(19) United States
(12) Patent Application Publication
(10) Pub. No.: US 2025/0225856 A1
(43) Pub. Date: Jul. 10, 2025

(54) LOAD HANDLING COMPLIANCE

(71) Applicant: Illinois Tool Works Inc., Glenview, IL (US)

(72) Inventors: David John WHITE, Smethwick (GB); Philip Andrew TOMLINSON, Northwich (GB); Depinder Singh KHELA, Birmingham (GB); Olivier Stephane PRIVAT, Dublin (IE)

(21) Appl. No.: 19/015,008

(22) Filed: Jan. 9, 2025

(30) Foreign Application Priority Data
Jan. 9, 2024 (GB) 2400308.9

(51) Int. Cl. G08B 21/18; G06Q 50/40

(52) U.S. Cl. CPC G08B 21/18; G06Q 50/40

(57) ABSTRACT

An apparatus for indicating a lack of compliance with a load handling procedure is provided. The apparatus comprises processing circuitry communicatively coupled to at least one memory. The processing circuitry is to: obtain data relating to a vehicle identifier detected at a load handling site, the data indicating: whether the vehicle identifier was detected in a load handling monitoring zone of the load handling site during a visit thereto by a corresponding vehicle; and whether the vehicle performed at least one action at the load handling site during the visit. The processing circuitry is further to determine whether to generate a notification indicating the vehicle to have not complied with the load handling procedure during the visit depending on the data. The processing circuitry is further to generate the notification depending on the determination.

### BACKGROUND

A load handling site, such as, for example, a refuse disposal site or a quarry, may require vehicles handling loads (i.e. disposing of or collecting loads) thereat to comply with a load handling procedure. Such a load handling procedure may require vehicles handling loads at the load handling site to e.g. validly perform a load weighing process to enable the weights of loads handled (such as e.g. refuse or quarried materials) to be determined, and in turn, to enable the owners of such vehicles to be correctly invoiced.

However, it may be that some vehicles fraudulently contravene such a load handling procedure without being detected. For example, it may be that some vehicles circumvent such a load weighing process of a load handling procedure by bypassing at least one weighbridge utilised for weighing vehicles as part of said load weighing process. In some cases, such fraudulent activity may be facilitated by an untrustworthy site operator, who may, for example, provide certain vehicles with access to a weighbridge bypass lane intended for use by e.g. emergency vehicles.

It is an object of the present disclosure to at least mitigate one or more of the problems of the prior art.

### BRIEF SUMMARY

In accordance with the present disclosure, there is provided an apparatus for indicating a lack of compliance with a load handling procedure, the apparatus comprising processing circuitry communicatively coupled to at least one memory, the processing circuitry to: obtain data (e.g. from one or more storage devices communicatively couplable to the apparatus) relating to a vehicle identifier detected at a load handling site, the data indicating: whether the vehicle identifier was detected in a load handling monitoring zone of the load handling site during a visit thereto by a corresponding vehicle; and whether the vehicle performed at least one action at the load handling site during the visit; determine whether to generate a notification indicating the vehicle to have not complied with the load handling procedure during the visit depending on the data; and generate the notification depending on the determination.

In accordance with the present disclosure, there is provided a (e.g. computer-implemented) method for indicating a lack of compliance with a load handling procedure, the method comprising: obtaining (e.g. from one or more storage devices) data relating to a vehicle identifier detected at a load handling site, the data indicating: whether the vehicle identifier was detected in a load handling monitoring zone of the load handling site during a visit thereto by a corresponding vehicle; and whether the vehicle performed at least one action at the load handling site during the visit; determining whether to generate a notification indicating the vehicle to have not complied with the load handling procedure during the visit depending on the data; and generating the notification depending on the determination.

Optionally, the at least one action comprises at least one non-compliant action.

Optionally, the at least one non-compliant action comprises any one or more of: bypassing an inbound weigh-in; bypassing an outbound weigh-in; invalidly performing an inbound weigh-in; invalidly performing an outbound weigh-in; carrying a radioactive load.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates that the vehicle performed at least one non-compliant action during the visit.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates that the vehicle identifier of the vehicle was detected in at least one non-compliant zone of the load handling site during the visit.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates that the vehicle identifier of the vehicle was not detected in at least one compliant zone of the load handling site during the visit.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates that the vehicle identifier of the vehicle was detected in at least one bypass monitoring zone (e.g. such as an inbound bypass monitoring zone, an outbound bypass monitoring zone, or both) of the load handling site during the visit.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates that the vehicle identifier of the vehicle was not detected in at least one weigh-in monitoring zone (e.g. such as inbound weigh-in zone data, outbound weigh-in zone data, or both) of the load handling site during the visit.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates at least one measured weight (e.g. such as an inbound weight, an outbound weight, or both) of the vehicle to be outside of a predetermined valid weight range.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates the vehicle to have been invalidly positioned during at least one weigh-in (e.g. such as an inbound weigh-in, an outbound weigh-in, or both) during the visit.

Optionally, the processing circuitry of the apparatus is to (or the method further comprises): determine (determining) to generate the notification when: the data indicates that the vehicle identifier of the vehicle was detected in the load handling monitoring zone of the load handling site during the visit; and the data further indicates the vehicle to have been carrying a radioactive load (e.g. a load emitting radiation above a (e.g. predetermined) radioactivity threshold) during the visit.

Optionally, the processing circuitry of the apparatus is to (or the method further comprises): determine (determining) to generate the notification when: the data indicates that the vehicle identifier of the vehicle was not detected in the load handling monitoring zone of the load handling site during the visit; and the data further indicates the vehicle to have been detected in at least one other monitoring zone of the load handling site during the visit.

Optionally, the at least one other monitoring zone comprises any one or more of: an inbound weigh-in monitoring zone; an outbound weigh-in monitoring zone; an inbound bypass monitoring zone; an outbound bypass monitoring zone.

Optionally, the processing circuitry of the apparatus is to (or the method further comprises): cause (causing) provision of the notification to one or more users or user accounts thereof.

Optionally, the processing circuitry of the apparatus is to (or the method further comprises): email (emailing) the notification to respective email accounts of the one or more users.

Optionally, the processing circuitry of the apparatus is to (or the method further comprises): cause (causing) provision of the notification to an online portal or a web application.

Optionally, the processing circuitry of the apparatus is to (or the method further comprises): cause (causing) transmission of the notification to respective user devices of the one or more users.

Optionally, the vehicle identifier comprises a registration number of the vehicle.

Optionally, the load handling site is one of: a refuse disposal site; a quarry.

According to an embodiment of the present disclosure, there is provided a system comprising: any apparatus above; one or more vehicle detection cameras (e.g. for detecting respective vehicle identifiers in one or more zones of the load handling site); and at least one storage device communicatively coupled to each of the apparatus and the one or more vehicle detection cameras.

Optionally, the system further comprises any one or more of: weight measurement circuitry communicatively coupled to the at least one storage device (the weight measurement circuitry for e.g. acquiring respective measured weight values of vehicles at the load handling site (e.g. during one or both of an inbound and an outbound weigh-in)); one or more vehicle positioning sensors communicatively coupled to the at least one storage device (the one or more vehicle positioning sensors for e.g. detecting invalid vehicle positions during weigh-ins (e.g. such as inbound weigh-ins, outbound weigh-ins, or both) at the load handling site); one or more radiation detectors communicatively coupled to the at least one storage device (the one or more radiation detectors for e.g. detecting respective radioactivity levels of vehicles at the load handling site).

According to an embodiment of the present disclosure, there is provided at least one computer program product comprising computer program instructions for causing processing circuitry to perform in accordance with the processing circuitry of any apparatus above or to cause performance of any method above.

According to an embodiment of the present disclosure, there is provided at least one (e.g. non-transitory) computer readable medium comprising executable instructions for causing processing circuitry to perform in accordance with the processing circuitry of any apparatus above or to cause performance of any method above.

### BRIEF DESCRIPTION OF THE DRAWINGS

Examples are further described with reference to the accompanying drawings, in which:

FIG. 1 schematically illustrates a system for indicating a lack of compliance with a load handling procedure;

FIG. 2 schematically illustrates an example of a load handling site;

FIG. 3 schematically illustrates an apparatus for implementing a compliance indicator; and

FIG. 4 is a flow diagram illustrating a method for indicating a lack of compliance with a load handling procedure.

### DETAILED DESCRIPTION

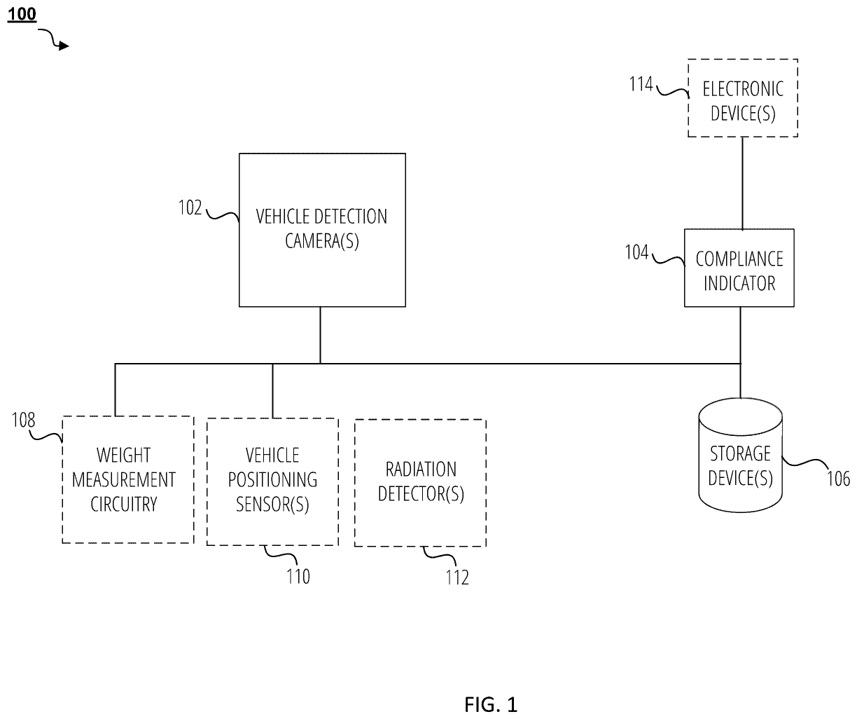

FIG. 1 schematically shows an example system 100 for indicating a lack of compliance with a load handling procedure implemented at a load handling site. The system 100 comprises: one or more vehicle detection cameras 102; a compliance indicator 104; and one or more storage devices 106.

In various configurations of the system 100, it may be that the system 100 optionally further comprises any one or more of: weight measurement circuitry 108; one or more vehicle positioning sensors 110; one or more radiation detectors 112; one or more electronic devices 114, such as one or more servers, one or more computers, one more users devices, such as mobile (cell) telephone(s), or combinations thereof.

The vehicle detection camera(s) 102 may comprise one or more cameras configured to (e.g. repeatedly) detect respective vehicle identifiers of vehicles present in one or more (e.g. predetermined) zones of the load handling site. As used herein, a vehicle identifier of a vehicle may refer to any feature or features of that vehicle capable of distinguishing that vehicle from one or more other vehicles.

For example, it may be that a vehicle identifier comprises a vehicle registration number. In such examples, it may be that the vehicle detection camera(s) 102 comprise one or more automatic number plate recognition (ANPR) cameras configured to capture images or video and to extract therefrom respective registration numbers (e.g. based on optical character recognition techniques) of vehicles within (e.g. predetermined area(s) of) the captured images or video.

Additionally or alternatively, it may be that a vehicle identifier comprises any other type of feature or features of a vehicle capable of distinguishing that vehicle from one or more other vehicles. For example, a vehicle identifier may comprise (e.g. in addition to, or as an alternative to comprising a vehicle registration number) any one or more of: a vehicle colour; a vehicle make; a vehicle model; a vehicle logo. In such examples, it may be that the vehicle detection camera(s) 102 comprise (e.g. in addition to or as an alternative to comprising one or more ANPR cameras) one or more (e.g. high-definition) cameras communicatively couplable or coupled to processing circuitry (not shown). Said processing circuitry may be configured to detect any one or more vehicle identifiers, such as any one or more of the vehicle identifiers disclosed herein, in images or video captured by the one or more (e.g. high-definition) cameras to which said processing circuitry is communicatively couplable or coupled. For example, it may be that said processing circuitry is configured to implement a trained artificial intelligence model, such as a trained machine learning model, such as trained neural network, or any other type of trained machine learning model, to provide for the detection of any one or more of the vehicle identifiers discussed above depending on images or video captured by the one or more (e.g. high definition) cameras.

It may be that the vehicle detection camera(s) 102 comprise a single camera whose field of view encompasses at least the above-mentioned one or more zones of the load handling site. Alternatively, it may be that the vehicle detection camera(s) 102 comprise a plurality of cameras whose fields of view collectively encompass at least said one or more zones of the load handling site. It may be that there is a one-to-one mapping between the vehicle detection camera(s) 102 and zones of the load handling site in which the vehicle detection camera(s) 102 are to detect vehicle identifiers. For example, it may be that the vehicle detection camera(s) 102 comprise: a first vehicle detection camera to detect vehicle identifiers in a first zone of the load handling site (such as e.g. a load handling monitoring zone); a second vehicle detection camera to detect vehicle identifiers in a second zone of the load handling site (such as e.g. a bypass monitoring zone, such as an inbound or an outbound bypass monitoring zone); a third vehicle detection camera to detect vehicle identifiers in a third zone of the load handling site (such as e.g. a weigh-in monitoring zone, such as such as an inbound or an outbound weigh-in monitoring zone); and so on.

It may be that each of the vehicle detection camera(s) 102, the weight measurement circuitry 108 (when present), the vehicle positioning sensor(s) 110 (when present), and the radiation detector(s) 112 (when present) are, or are to be located at the load handling site. Additionally, it may be that one or both of the storage device(s) 106 and the compliance indicator 104 are, or are to be located (or are implemented by way of processing circuitry located, or to be located) at the load handling site. Alternatively, it may be that one or both of the storage device(s) 106 and the compliance indicator 104 are, or are to be located (or are implemented by way of processing circuitry located, or to be located) remotely from the load handling site.

The storage device(s) 106 of the system 100 may comprise one or more memories operable to store machine-readable data. Each of the one or more memories may comprise any suitable type of memory such as, for example, cache memory, random access memory (RAM), read only memory (ROM), flash memory, magnetic or optical disk or any combination thereof. It is to be understood that when data is described herein as being stored in the storage device(s) 106, said data may be e.g. stored in a respective memory of the storage device(s) 106 or e.g. distributed across one or more memories of the storage device(s) 106. It may be that the storage device(s) 106 are comprised within one or more (e.g. cloud) servers.

The functionality of the compliance indicator 104 described herein may be implemented in software (e.g. such as software executed by processing circuitry of one or more (e.g. cloud) servers, or software executed by any other type of processing circuitry), hardware, or firmware, or a combination of any of software, hardware, and firmware. For example, the compliance indicator 104 may comprise processing circuitry. The processing circuitry may be configured to retrieve and execute computer program instructions stored in at least one memory communicatively coupled to the processing circuitry to thereby provide the functionality described herein. Each of said at least one memory may comprise any suitable memory such as cache memory, random access memory (RAM), read only memory (ROM), flash memory, magnetic or optical disk or any combination thereof. It may be that the storage device(s) 106 comprise said at least one memory. Alternatively, it may be that said at least one memory is separate from the storage device(s) 106. It may be that said processing circuitry is processing circuitry of one or more (e.g. cloud) servers, or any other type of processing circuitry.

The storage device(s) 106 may be communicatively couplable or coupled to each of the vehicle detection camera(s) 102 and the compliance indicator 104 by way of any suitable communicative coupling. Additionally, the storage device(s) 106 may be communicatively couplable or coupled to each of the weight measurement circuitry 108 (when present), the vehicle positioning sensor(s) 110 (when present), and the radiation detector(s) 112 (when present) by way of any suitable communicative coupling. It is to be understood that any communitive coupling discussed herein may comprise any suitable type of (e.g. direct or indirect e.g. by way of intervening circuitry) communicative coupling, such as a wired or a wireless communicative coupling.

It may be that each of the compliance indicator 104 and the storage device(s) 106 are implemented by way of one or more (e.g. cloud) servers. In such examples, it may be that any one or more of the vehicle detection camera(s) 102, the weight measurement circuitry 108 (when present), the vehicle positioning sensor(s) 110 (when present), and the radiation detector(s) 112 (when present) are communicatively couplable or coupled to the storage device(s) 106 by way of a first network, such as a wide area network (WAN), such as the internet. In such examples, it may be that any one or more of the vehicle detection camera(s) 102, the weight measurement circuitry 108 (when present), the vehicle positioning sensor(s) 110 (when present), and the radiation detector(s) 112 (when present) are communicatively couplable or coupled to the first network by way of a second network, such as a local area network (LAN) (e.g. implemented at the load handling site), such as a wired or a wireless LAN. However, it is to be understood that the present disclosure is not so limited, and each of the vehicle detection camera(s) 102, the compliance indicator 104, the weight measurement circuitry 108 (when present), the vehicle positioning sensor(s) 110 (when present), and the radiation detector(s) 112 (when present) may be communicatively couplable or coupled to the at least one storage device(s) 106 in any other suitable way.

In configurations of the system 100 wherein the system 100 comprises the one or more electronic devices 114, it may be that the compliance indictor 104 is communicatively couplable or coupled to the electronic device(s) 114 by way of any suitable communicative coupling, such as e.g. by way of a network, such as a wide area network, such as the internet, or by way of any other suitable communicative coupling.

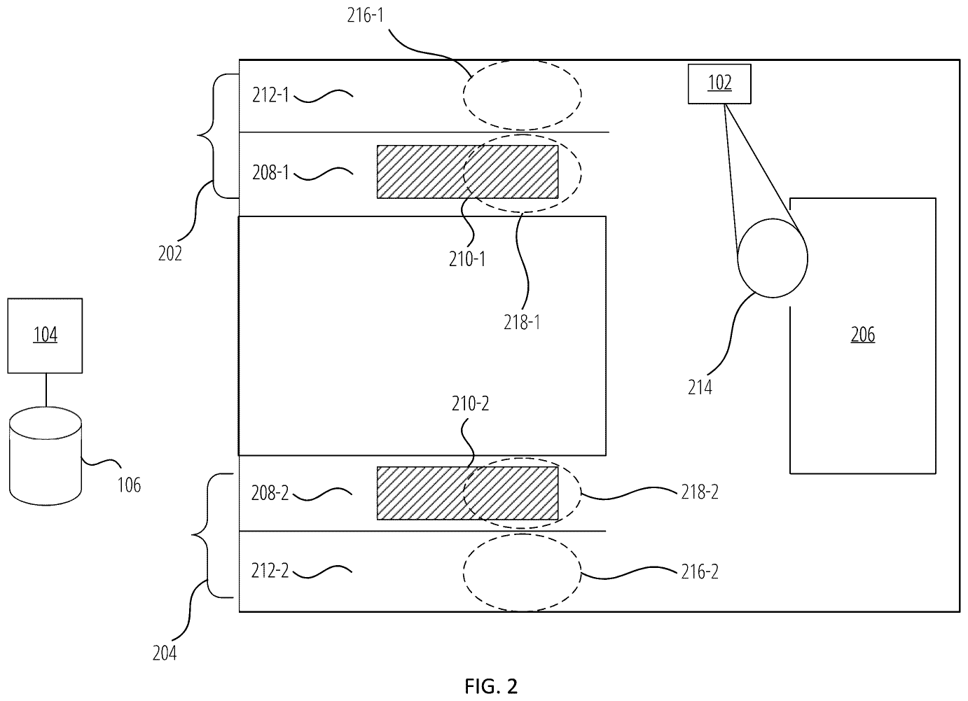

For case of explanation, the following describes the functionality of the system 100 in relation to the example load handling site shown in FIG. 2, at which an example load handling procedure is implemented. However, it is to be understood that the configuration of the load handling site shown in FIG. 2 is merely for illustrative purposes and that the present disclosure is not so limited. The system 100 may be suitable for implementation at load handling sites having configurations different to that of the load handling site shown in FIG. 2.

The load handling site shown in FIG. 2 may comprise any type of site at which loads are to be handled by vehicles visiting the load handling site. As used herein, the term “load handling” and derivatives thereof are used to refer to a load being either disposed of from or collected by (i.e. loaded onto) a vehicle. It is to be understood that said term and said derivatives thereof are not necessarily used to mean that such loads are e.g. physically handled by an operator of a vehicle, although this may be encompassed by said term(s).

It may be that the load handling site comprises a load disposal site such as a refuse disposal site. In such examples, it may be that loads (e.g. comprising refuse) are to be disposed of from vehicles visiting the load disposal site. Alternatively, it may be that the load handling site comprises a quarry. In such examples, it may be that loads comprising quarried materials are to be collected by vehicles visiting the quarry. In other examples, the load handling site may be any other type of load handling site.

The load handling procedure implemented at the load handling site shown in FIG. 2 may require that vehicles handling loads at the load handling site during respective visits thereto comply with (i.e. validly perform) a load weighing process during said visits. In such examples, it may be that a given vehicle does not comply with the load handling procedure at least when that vehicle handles a load at the load handling site and when that vehicle does not comply (i.e. does not validly perform) the load weighing process during said visit (e.g. by way of performing at least one non-compliant action e.g. circumventing said load weighing process).

It may be that the load handling procedure implemented at the load handling site additionally or alternatively requires (e.g. at least in cases wherein the load handling site is a load disposal site) that loads carried by vehicles (e.g. for disposal) are of a compliant load type. It may be that radioactive loads (such as e.g. loads which emit radiation e.g. above a (e.g. predetermined) radioactivity threshold) are not of a compliant load type. In such examples, it may be that a given vehicle does not comply with the load handling procedure at least when that vehicle carries (e.g. for disposal) a load of a non-compliant load type, such as e.g. a radioactive load.

It may be that, for each vehicle complying therewith, the load weighing process of the load handling procedure determines a load weight value of a load handled by that vehicle (i.e. a weight value of a load disposed of from or collected by that vehicle) during a corresponding visit thereby to the load handling site.

As used herein, a visit by a vehicle to the load handling site may be used to refer to a particular temporal period extending from a time at which that vehicle enters the load handling site to the next time at which that vehicle exits the load handling site.

It may be that the load weighing process determines a load weight value of a load handled by a vehicle during a visit thereby to the load handling site by measuring a weight of the vehicle before and after the handling of that load. The weight of a vehicle prior to the handling of a load thereby during a visit to the load handling site may be referred to as the “inbound weight” of that vehicle. The weight of a vehicle subsequent to the handling of a load thereby during a visit to the load handling site may be referred to as the “outbound weight” of that vehicle. The term “inbound weigh-in” may be used to refer to a weight measurement for measuring the inbound weight of a vehicle. The term “outbound weigh-in” may be used to refer to a weight measurement for measuring the outbound weight of a vehicle.

The load weighing process may determine a load weight value of a load handled by a vehicle during a particular visit thereby to the load handling site depending on a difference between the inbound weight and the outbound weight of that vehicle during that visit. For example, it may be that said load weight value is determined to equal the difference between the inbound weight and the outbound weight for that vehicle during that visit.

Accordingly, to comply with the load weighing process, it may be that vehicles handling loads at the load handling site are required to have both their inbound weight and their outbound weight validly measured by a system implementing the load weighing process (which may be referred to as a “load weighing system”). Hence, vehicles which handle loads at the load handling site and which bypass one or both of an inbound weigh-in and an outbound weigh-in, or which invalidly perform one or both of an inbound weigh-in and an outbound weigh-in (e.g. by being invalidly positioned on a corresponding weigh station, or otherwise), may not comply with the load weighing process.

As will be discussed further below, in cases where a given vehicle does not comply with the load handling procedure implemented at the load handling site, the system 100 may be advantageously configured to generate a notification indicating such a lack of compliance, thereby mitigating against such activity. For example, it may be that the system 100 is configured to generate said notification when a given vehicle is detected to have handled a load at the load handling site but to have not complied with the load weighing process. Additionally or alternatively, the system 100 may be configured to generate said notification when a given vehicle is detected to be carrying a load of a non-compliant load type, such as a radioactive load.

Referring back to the load handling site shown in FIG. 2, the load handling site comprises: a site entrance 202; a site exit 204; a load handling zone 206; an inbound weigh station lane 208-1 forming part of a thoroughfare connecting the site entrance 202 and the load handling zone 206; an inbound weigh station 210-1 located in the inbound weigh station lane 208-1; an outbound weigh station lane 208-2 forming part of a thoroughfare connecting the load handling zone 206 and the site exit 204; an outbound weigh station 210-2 located in the outbound weigh station lane 208-2; an inbound bypass lane 212-1; and an outbound bypass lane 212-2.

The load handling zone 206 is an area of the load handling site in which loads are to be handled by vehicles. In examples wherein the load handling site comprises a load disposal site, the load handling zone 206 may correspond to a designated area at the load disposal site at which loads are to be disposed of. For example, in examples wherein the load handling site comprises a refuse disposal site, the load handling zone 206 may comprise a so-called tipping hall or any other area suitable for the disposal of refuse. In examples where the load handling site comprises a quarry, the load handling zone 206 may comprise an area of the quarry at which quarried materials are disposed for the collection thereof.

Each of the inbound weigh station 210-1 and the outbound weigh station 210-2 comprises a respective set of electronic scales operable to measure weights of vehicles positioned thereon and to generate corresponding weight measurement values. Each of the inbound weigh station 210-1 and the outbound weigh station 210-2 may comprise, for example, a respective weighbridge, or any other type of electronic scales suitable for measuring weights (e.g. of vehicles).

The inbound weigh station 210-1 is positioned within the inbound weigh station lane 208-1 between the site entrance 202 and the load handling zone 206 such that vehicles traversing the inbound weigh station lane 208-1 are (e.g. required) to pass over the inbound weigh station 210-1 e.g. for performance of an inbound weigh-in thereat.

The outbound weigh station 210-2 is positioned within the outbound weigh station lane 208-2 between the load handling zone 206 and the site exit 204 such that vehicles traversing the outbound weigh station lane 208-1 are (e.g. required) to pass over the outbound weigh station 210-2 e.g. for performance of an outbound weigh-in thereat.

Each of the inbound and outbound weigh stations may be communicatively couplable or coupled to the load weighing system to facilitate the load weighing process. It is to be understood that the load weighing system implementing the load weighing process may be implemented by any suitable system in any suitable way. It may be that the load weighing system is a (e.g. fully) automated load weighing system. Alternatively, it may be that the load weighing system is not automated, or is partially automated. The term “load weighing system” may be used to refer to e.g. a system interfacing with the inbound weigh station 210-1 and the outbound weigh station 210-2 to provide for the functionality of the load weighing process described herein. It may be that the load weighing system is separate from the system 100. That is, it may be that the load weighing system and the system 100 are operable to function independently of each other. Alternatively, it may be that the load weighing system and the system 100 are (e.g. at least partially) integrated.

The inbound bypass lane 212-1 may be part of a thoroughfare connecting the site entrance 202 and the load handling zone 206, and bypassing the inbound weigh station 210-1. Accordingly, the inbound bypass lane 212-1 may provide a route by which vehicles can enter the load handling site and access the load handling zone 206 without passing over the inbound weigh station 210-1.

The outbound bypass lane 212-1 may be part of a thoroughfare connecting the load handling zone 206 and the site exit 204, and bypassing the outbound weigh station 210-2. Accordingly, the outbound bypass lane 212-2 may provide a route by which vehicles can exit the load handling site having accessed the load handling zone 206 without passing over the outbound weigh station 210-2.

It may be that the inbound bypass lane 212-1 and the outbound bypass lane 212-2 are intended for use by vehicles not required to participate in the load weighing process, such as, for example, emergency vehicles accessing the load handling site. It may be that one or both of the inbound and the outbound bypass lanes comprise a respective barrier (not shown) arranged to selectively enable authorised vehicles to enter or to exit that bypass lane, and to selectively block unauthorised vehicles from entering or exiting that bypass lane. However, it may be that unauthorised vehicles can gain access to one or both of the inbound bypass lane 212-1 and the outbound bypass lane 212-2 (e.g. with the aid of an untrustworthy site operator) and thereby fraudulently circumvent performance of one or both of an inbound weigh-in and an outbound weigh-in.

Referring back to the system 100, the system 100 may be configured to determine whether to, and to correspondingly generate, a notification (which may be referred to as a “non-compliance notification”) indicating a given vehicle to have not complied with the load handling procedure at the load handling site during a particular visit thereto by that vehicle.

It may be that a vehicle does not comply with the load handling procedure of the load handling site during a visit thereto at least when that vehicle handles a load during said visit and when that vehicle additionally performs at least one non-compliant action during said visit. The term “non-compliant” action may be used to refer to any action by a vehicle that is contrary to the load handling procedure. Non-compliant actions may include, for example, any one or more of: bypassing or performing an invalid inbound weigh-in; bypassing or performing an invalid outbound-weigh in; carrying or disposing of load of a non-compliant load type (e.g. such as a radioactive load (e.g. at least in examples wherein the load handling site is a load disposal site).

As will be discussed further below, it may be that the system 100 is configured to generate a notification indicating a given vehicle to have not complied with the load handling procedure during a particular visit depending on data generated by the system 100 associated with a vehicle identifier of the given vehicle and corresponding to that particular visit.

For example, it may be that the system 100 is configured to generate a non-compliance notification depending on data generated by the system 100 indicating whether the given vehicle handled a load at the load handling said during the particular visit, and further indicating whether any one or more of: the given vehicle was detected in one or more non-compliant zones of the load handling site during the particular visit (e.g. as such inbound bypass monitoring zone, an outbound bypass monitoring zone, or any other predetermined zone or zones of the load handling site which (e.g. unauthorised) vehicles are not intended to enter); the given vehicle was detected in one or more compliant zones of the load handling site during the particular visit (e.g. such as an inbound weigh-in monitoring zone, an outbound weigh-in monitoring zone, or any other predetermined zone or zones of the load handling site which vehicles complying with the load handling procedure are intended to enter); an invalid inbound or outbound weight of the given vehicle was measured during the particular visit; an invalid positioning of the particular vehicle during one or more weigh-ins (e.g. such as an inbound weigh-in, an outbound weigh-in, or both) was detected during the particular visit; the given vehicle was detected to be carrying a load of a non-compliant load type, such as a radioactive load, during the particular visit.

Advantageously, generating non-compliance notifications depending on data generated by the system 100 indicating whether the given vehicle handled a load at the load handling site may provide for the generation of particularly reliable and relevant notifications.

For example, if whether a vehicle handled a load at the load handling site was not factored in to generating non-compliance notifications, and e.g. non-compliance notifications were generated based solely on e.g. a determination that a vehicle did not perform a weigh-in such as an inbound or outbound weigh-in, such non-compliance notifications may be frivolous in the case that that vehicle was not required to perform a weigh-in because it did not handle a load.

However, while it may be particularly advantageous to generate a non-compliance notification depending on data generated by the system 100 indicating whether a given vehicle handled a load at the load handling site, the present disclosure is not so limited, and it may be that generation of a non-compliance notification by the system 100 does not depend on whether the system 100 generated data indicating whether a vehicle handled a load at the load handling site.

As will be discussed further below, it may be that the system 100 is configured to provide or cause provision of the generated non-compliance notification to one or more (e.g. authorised) users or user accounts thereof. Accordingly, such user(s) may advantageously be alerted of non-compliant activity by a given vehicle during a visit to the load handling site.

As will also be discussed further below, to provide for the generation of non-compliance notifications as discussed above, the system 100 may be configured to generate and to store, in the storage device(s) 106, various data associated with respective vehicle identifiers detected at the load handling site. Further details of how such data may be generated by the system 100, and how the system 100 may be configured to generate a non-compliance notification depending thereon are discussed below. It is to be understood that the particular data generated by the system 100 may depend on a configuration of the system 100. The system 100 may configured to generate any one or more of the data types disclosed herein in any combination.

### Load Handling Data

In various configurations, it may be that the system 100 is configured to generate and store, in the storage device(s) 106, respective load handling data. It may be that each of the respective load handling data stored in the storage device(s) 106 relates to (e.g. indicates) whether a respective vehicle identifier was detected in a load handling monitoring zone 214 of the load handling site during a particular visit thereto.

The load handling monitoring zone 214 may comprise one or more areas of the load handling site which vehicles are (e.g. likely or e.g. required) to enter in order to handle, when handling, or having handled a load in the load handling zone 206.

For example, the load handling monitoring zone 214 may encompass one or more portions of, or an entirety of the load handling zone 206. For example, the load handling monitoring zone 214 may encompass one or both of an entrance and an exit of the load handling zone 206 (if present).

Additionally or alternatively, the load handling monitoring zone 214 may encompass one or more areas adjacent and external to the load handling zone 206 which vehicles are (e.g. likely or e.g. required) to pass through in order to access or in order to exit the load handling zone 206.

Accordingly, load handling data stored in the storage device(s) 106 indicating a vehicle identifier to have been detected in the load handling monitoring zone 214 during a particular visit to the load handling site may indicate (e.g. at least imply) that a vehicle corresponding to that vehicle identifier is going to handle, or has handled a load in the load handling zone 206.

Each of the respective load handling data may be generated by way of the vehicle detection camera(s) 102. For example, it may be that the vehicle detection camera(s) 102 are configured to (e.g. repeatedly) detect respective vehicle identifiers of vehicles present in the load handling monitoring zone 214 of the load handling site and to (e.g. repeatedly) store, cause storage of, or provide for the storage of, in the storage device(s) 106, each of the respective load handling data. For example, it may be that the vehicle detection camera(s) 102 are configured to generate and to transmit said load handling data to the storage device(s) 106 for storage therein. Alternatively, it may be that said load handling data are otherwise based on data generated by the vehicle detection camera(s) 102 relating to detection instances of vehicle identifiers detected in the load handling monitoring zone 214. In such examples, the system 100 may cause storage of the load handling data in the storage device(s) 106 depending on said data generated by the vehicle detection camera(s) 102 in any suitable way, for example, by way of intervening processing circuitry of the system 100 (not shown).

It may be that each of the respective load handling data stored in the storage device(s) 106 is associated with (e.g. linked to) a respective vehicle identifier. Additionally, it may be that each of the respective load handling data stored in the storage device(s) is associated (e.g. linked to) or at least associable (i.e. capable of be associated with) with a particular visit to the load handling site during which that vehicle identifier was detected by the vehicle detection camera(s) 102 in the load handling monitoring zone 214. It may be that each of the respective load handling data stored in the storage device(s) 106 indicates the vehicle identifier with which that load handling data is associated to have been detected in the load handling monitoring zone 214 during the particular visit to the load handling site with which that load handling data is also associated or associable.

### Non-Compliant Zone Data

In various configurations of the system 100, it may be that the system 100 is configured to provide for the detection of respective vehicle identifiers in one or more non-compliant zones of the load handling site by generating and storing, in the storage device(s) 106, respective non-compliant zone data (e.g. such as inbound bypass zone data or outbound bypass zone data). It may be that each of the respective non-compliant zone data stored in the storage device(s) 106 relates to (e.g. indicates) whether a respective vehicle identifier was detected in a non-compliant zone of the load handling site (e.g. such as an inbound bypass monitoring zone, an outbound bypass monitoring zone, or any other zone of the load handling site which (e.g. unauthorised) vehicles are not intended to enter) during a particular visit thereto. Each of the respective non-compliant zone data may be generated by way of the vehicle detection camera(s) 102. The following describes examples of how inbound bypass zone data and outbound bypass zone data (which may be examples of non-compliant zone data) may be generated and stored by the system 100. However it is to be understood that the non-compliant zone data of the present disclosure is not limited to one or both of the inbound bypass zone data and the outbound bypass zone data. For example, it may be that the system 100 is configured to generate and store non-compliant zone data relating to (e.g. indicating) whether a respective vehicle identifier was detected in a non-compliant zone other than an inbound or an outbound bypass monitoring zone. Such non-compliant data may be generated in a similar way to the inbound bypass zone data and the outbound bypass zone data.

### Inbound Bypass Zone Data

In various configurations, the system 100 may be configured to generate and to store, in the at least one storage device(s) 106, inbound bypass zone data. It may be that each of the respective inbound bypass zone data stored in the storage device(s) 106 relates to (e.g. indicates) whether a respective vehicle identifier was detected in an inbound bypass monitoring zone 216-1 of the load handling site during a particular visit thereto.

The inbound bypass monitoring zone 216-1 may comprise one or more areas of the load handling site which vehicles may (e.g. be likely to or e.g. be required to) pass through to bypass the inbound weigh station 210-1 e.g. to enter the load handling site and proceed to access the load handling zone 206 without passing over the inbound weigh station 210-1. For example, the inbound bypass monitoring zone 216-1 may encompass at least a portion of the inbound bypass lane 212-1. Accordingly, detection of a vehicle identifier in the inbound bypass monitoring zone 216-1 may indicate (e.g. at least imply) that a corresponding vehicle did not perform an inbound weigh-in at the inbound weigh station 210-1.

Each of the respective inbound bypass zone data may be generated by way of the vehicle detection camera(s) 102. For example, it may be that the vehicle detection camera(s) 102 are configured to (e.g. repeatedly) detect respective vehicle identifiers of vehicles present in the inbound bypass monitoring zone 216-1 and to (e.g. repeatedly) store, cause storage of, or provide for the storage of, in the storage device(s) 106, respective inbound bypass zone data. For example, it may be that the vehicle detection camera(s) 102 are configured to generate and to transmit said inbound bypass zone data to the storage device(s) 106 for storage therein. Alternatively, it may be that said inbound bypass zone data are otherwise based on data generated by the vehicle detection camera(s) 102 relating to detection instances of vehicle identifiers detected in the inbound bypass monitoring zone 216-1. In such examples, the system 100 may cause storage of the inbound bypass zone data in the storage device(s) 106 depending on said data generated by the vehicle detection camera(s) 102 in any suitable way, for example, by way of intervening processing circuitry of the system 100 (not shown).

It may be that each of the respective inbound bypass zone data stored in the storage device(s) 106 is associated with (e.g. linked to) a respective vehicle identifier. Additionally, it may be that each of the of the respective inbound bypass zone data is associated (e.g. linked to) or at least associable with a particular visit to the load handling site during which that vehicle identifier was detected by the vehicle detection camera(s) 102 in the inbound bypass monitoring zone 216-1. It may be that each of the respective inbound bypass zone data stored in the storage device(s) 106 indicates the vehicle identifier with which that inbound bypass data is associated to have been detected in the inbound bypass monitoring zone 216-1 during the particular visit to the load handling site with which that inbound bypass zone data is also associated or associable.

### Outbound Bypass Zone Data

In various configurations, the system 100 may be configured to generate and to store, in the at least one storage device(s) 106, outbound bypass zone data. It may be that each of the respective outbound bypass zone data stored in the storage device(s) 106 relates to (e.g. indicates) whether a respective vehicle identifier was detected in an outbound bypass monitoring zone 216-2 of the load handling site during a particular visit thereto.

The outbound bypass monitoring zone 216-2 may comprise one or more areas of the load handling site which vehicles may (e.g. be likely to or e.g. be required to) pass through to bypass the outbound weigh station 210-2 e.g. to exit the load handling site having accessed the load handling zone 206 without passing over the outbound weigh station 210-2. For example, the outbound bypass monitoring zone 216-2 may encompass at least a portion of the outbound bypass lane 212-2. Accordingly, detection of a vehicle identifier in the outbound bypass monitoring zone 216-2 may indicate (e.g. at least imply) that a corresponding vehicle did not perform an outbound weigh-in at the outbound weigh station 210-2.

Each of the respective outbound bypass zone data may be generated by way of the vehicle detection camera(s) 102. For example, it may be that the vehicle detection camera(s) 102 are configured to (e.g. repeatedly) detect respective vehicle identifiers of vehicles present in the outbound bypass monitoring zone 216-2 and to (e.g. repeatedly) store, cause storage of, or provide for the storage of, in the storage device(s) 106, respective outbound bypass zone data. For example, it may be that the vehicle detection camera(s) 102 are configured to generate and to transmit said outbound bypass zone data to the storage device(s) 106 for storage therein. Alternatively, it may be that said outbound bypass zone data are otherwise based on data generated by the vehicle detection camera(s) 102 relating to detection instances of vehicle identifiers detected in the outbound bypass monitoring zone 216-2. In such examples, the system 100 may cause storage of the outbound bypass zone data in the storage device(s) 106 depending on said data generated by the vehicle detection camera(s) 102 in any suitable way, for example, by way of intervening processing circuitry of the system 100 (not shown).

It may be that each of the respective outbound bypass zone data stored in the storage device(s) 106 is associated with (e.g. linked to) a respective vehicle identifier. Additionally, it may be that each of the respective outbound bypass zone data stored in the storage device(s) 106 is associated (e.g. linked to) or at least associable with a particular visit to the load handling site during which that vehicle identifier was detected by the vehicle detection camera(s) 102 in the outbound bypass monitoring zone 216-2. It may be that each of the respective outbound bypass zone data stored in the storage device(s) 106 indicates the vehicle identifier with which that outbound bypass data is associated to have been detected in the outbound bypass monitoring zone 216-2 during the particular visit to the load handling site with which that outbound bypass zone data is also associated or associable.

### Compliant Zone Data

In various configurations of the system 100, it may be that the system 100 is configured to provide for the detection of respective vehicle identifiers in one or more compliant zones of the load handling site by generating and storing, in the storage device(s) 106, respective compliant zone data (e.g. such as inbound weigh-in zone data or outbound weigh-in zone data). It may be that each of the respective compliant zone data stored in the storage device(s) 106 relates to (e.g. indicates) whether a respective vehicle identifier was detected in a compliant zone of the load handling site during a particular visit thereto (e.g. such as an inbound weigh-in monitoring zone, an outbound weigh-in monitoring zone, or any other zone of the load handling site which vehicles are intended to enter to comply with the load handling procedure). Each of the respective compliant zone data may be generated by way of the vehicle detection camera(s) 102. The following describes examples of how inbound weigh-in zone data and outbound weigh-in zone data (which may be examples of compliant zone data) may be generated and stored by the system 100. However it is to be understood that the compliant zone data of the present disclosure is not limited to one or both of the inbound weigh-in zone data and the outbound weigh-in zone data. For example, it may be that the system 100 is configured to generate and store compliant zone data relating to (e.g. indicating) whether a respective vehicle identifier was detected in a compliant zone other than an inbound or an outbound weigh-in monitoring zone. Such non-compliant data may be generated in a similar way to the inbound weigh-in zone data and the outbound weigh-in zone data.

### Inbound Weigh-In Zone Data

In various configurations, the system 100 may be configured to generate and to store, in the at least one storage device(s) 106, inbound weigh-in zone data. It may be that each of the respective inbound weigh-in zone data stored in the storage device(s) 106 relates to (e.g. indicates) whether a respective vehicle identifier was detected in an inbound weigh-in monitoring zone 218-1 of the load handling site during a particular visit thereto.

The inbound weigh-in monitoring zone 218-1 may comprise one or more areas of the load handling site which vehicles are (e.g. likely or e.g. required) to enter prior to, during, or after performing an inbound weigh-in at the inbound weigh station 210-1. For example, the inbound weigh-in monitoring zone 218-1 may encompass at least a portion of the inbound weigh station lane 208-1 in which at least part of the inbound weigh station 210-1 is located. Alternatively, the inbound weigh-in monitoring zone 218-1 may encompass at least a portion of the inbound weigh station lane 208-1 (e.g. immediately) adjacent a portion thereof in which the inbound weigh station 210-1 is located e.g. a portion between the inbound weigh station 210-1 and the load handling zone 206 or e.g. a portion between the inbound weigh station 210-1 and the site entrance 202.

Each of the respective inbound weigh-in zone data may be generated by way of the vehicle detection camera(s) 102. For example, it may be that the vehicle detection camera(s) 102 are configured to (e.g. repeatedly) detect respective vehicle identifiers of vehicles present in the inbound weigh-in monitoring zone 218-1 and to (e.g. repeatedly) store, cause storage of, or provide for the storage of, in the storage device(s) 106, respective inbound weigh-in zone data. For example, it may be that the vehicle detection camera(s) 102 are configured to generate and to transmit said inbound weigh-in zone data to the storage device(s) 106 for storage therein. Alternatively, it may be that said inbound weigh-in zone data are otherwise based on data generated by the vehicle detection camera(s) 102 relating to detection instances of vehicle identifiers detected in the inbound weigh-in monitoring zone 218-1. In such examples, the system 100 may cause storage of the inbound weigh-in zone data in the storage device(s) 106 depending on said data generated by the vehicle detection camera(s) 102 in any suitable way, for example, by way of intervening processing circuitry of the system 100 (not shown).

It may be that each of the respective inbound weigh-in zone data stored in the storage device(s) 106 is associated with (e.g. linked to) a respective vehicle identifier. Additionally, it may be that each of the respective inbound weigh-in zone data stored in the storage device(s) 106 is associated (e.g. linked to) or at least associable with a particular visit to the load handling site during which that vehicle identifier was detected by the vehicle detection camera(s) 102 in the inbound weigh-in monitoring zone 218-1. It may be that each of the respective inbound weigh-in zone data stored in the storage device(s) 106 indicates the vehicle identifier with which that inbound weigh-in zone data is associated to have been detected in the inbound weigh-in monitoring zone 218-1 during the particular visit to the load handling site with which that inbound bypass zone data is also associated or associable.

### Outbound Weigh-In Zone Data

In various configurations of the of the system 100, the system 100 may be configured to generate and to store, in the at least one storage device(s) 106, outbound weigh-in zone data. It may be that each of the respective outbound weigh-in zone data stored in the storage device(s) 106 relates to (e.g. indicates) whether a respective vehicle identifier was detected in an outbound weigh-in monitoring zone 218-2 of the load handling site during a particular visit thereto.

The outbound weigh-in monitoring zone 218-2 may comprise one or more areas of the load handling site which vehicles are (e.g. likely or e.g. required) to enter prior to, during, or after performing a weigh-in at the outbound weigh station 210-2. For example, the outbound weigh-in monitoring zone 218-2 may encompass at least a portion of the outbound weigh station lane 208-2 in which at least part of the outbound weigh station 210-2 is located. Alternatively, the outbound weigh-in monitoring zone 218-2 may encompass at least a portion of the outbound weigh station lane 208-2 (e.g. immediately) adjacent a portion thereof in which the outbound weigh station 210-2 is located e.g. a portion between the outbound weigh station 210-2 and the load handling zone 206 or e.g. a portion between the outbound weigh station 210-2 and the site exit 204.

Each of the respective outbound weigh-in zone data may be generated by way of the vehicle detection camera(s) 102. For example, it may be that the vehicle detection camera(s) 102 are configured to (e.g. repeatedly) detect respective vehicle identifiers of vehicles present in the outbound weigh-in monitoring zone 218-1 and to (e.g. repeatedly) store, cause storage of, or provide for the storage of, in the storage device(s) 106, respective outbound weigh-in zone data. For example, it may be that the vehicle detection camera(s) 102 are configured to generate and to transmit said outbound weigh-in zone data to the storage device(s) 106 for storage therein. Alternatively, it may be that said outbound weigh-in zone data are otherwise based on data generated by the vehicle detection camera(s) 102 relating to detection instances of vehicle identifiers detected in the outbound weigh-in monitoring zone 218-2. In such examples, the system 100 may cause storage of the outbound weigh-in zone data in the storage device(s) 106 depending on said data generated by the vehicle detection camera(s) 102 in any suitable way, for example, by way of intervening processing circuitry of the system 100 (not shown).

It may be that each of the respective outbound weigh-in zone data stored in the storage device(s) 106 is associated with (e.g. linked to) a respective vehicle identifier. Additionally, it may be that each of the respective outbound weigh-in zone data stored in the storage device(s) 106 is associated (e.g. linked to) or at least associable with a particular visit to the load handling site during which that vehicle identifier was detected by the vehicle detection camera(s) 102 in the outbound weigh-in monitoring zone 218-2. It may be that each of the respective outbound weigh-in zone data stored in the storage device(s) 106 indicates the vehicle identifier with which that outbound weigh-in data is associated to have been detected in the outbound weigh-in monitoring zone 218-2 during the particular visit to the load handling site with which that outbound weigh-in zone data is also associated or associable.

### Weight Data

### Inbound Weight Data

In various configurations of the system 100, it may be that the system 100 is configured to generate and store, in the storage device(s) 106, respective inbound weight data. In such examples, it may be that the system 100 further comprises the weight measurement circuitry 108. It may be that each of the respective inbound weight data stored in the storage device(s) 106 relates to (e.g. indicates e.g. comprises or consists of) a measured weight value measured by the inbound weigh station 210-1 corresponding to a particular vehicle having performed an inbound weigh-in at, or having otherwise traversed the inbound weigh station 210-1 (e.g. without pausing on said weigh station to perform an inbound weigh-in). For example, it may be that said measured weight value is generated by the inbound weigh station 210-1 as a result of said particular vehicle performing an inbound weigh-in at, or otherwise traversing the inbound weigh station 210-1.

It may be that each of the respective inbound weight data stored in the storage device(s) 106 is associated with (e.g. linked to) a respective vehicle identifier of the vehicle to which that inbound weight data corresponds. Additionally, it may be that each of the respective inbound weight data stored in the storage device(s) 106 is associated (e.g. linked to) or at least associable with and a particular visit to the load handling site during which that inbound weight data was generated.

As will be discussed further below, it may be that each of the respective inbound weight data is generated by way of the weight measurement circuitry 108, and that each of the respective inbound weight data is associated with (e.g. linked to) a vehicle identifier of a vehicle to which it corresponds by way of the vehicle detection camera(s) 102.

It may be that the weight measurement circuitry 108 is communicatively couplable or coupled to the inbound weigh station 210-1 and configured to (e.g. repeatedly) receive respective weight measurement values generated by the inbound weigh station 210-1 by way of said communicative coupling therebetween, and to generate respective inbound weight data relating to (e.g. indicating e.g. comprising or consisting of) respective ones of said weight measurement values. It may be that the weight measurement circuitry 108 is configured to (e.g. repeatedly) store, cause storage of, or provide for the storage of, in the storage device(s) 106, each of said respective inbound weight data.

To provide for the association of respective ones of the inbound weight data with respective vehicle identifiers, it may be that the vehicle detection camera(s) 102 are configured to detect respective vehicle identifiers of vehicles present in the inbound weigh-in monitoring zone 218-1. In such examples, it may be that the system 100 is configured to (e.g. repeatedly) associate respective ones of the inbound weight data generated by the weight measurement circuitry 108 and respective vehicles identifiers corresponding to said inbound weight data depending on a relative timing between a time at which said inbound weight data is generated by the weight measurement circuitry 108 (or e.g. a time at which the weight measurement value to which that inbound weight data relates is received by the weight measurement circuitry 108 from the inbound weigh station 210-1) and a time at which said vehicle identifiers are detected in the inbound weigh-in monitoring zone 218-1 by the vehicle detection camera(s) 102.

The system 100 may be configured to associate respective ones of the inbound weight data with respective vehicle identifiers in any suitable way. As an illustrative example, it may be that the weight measurement circuitry 108 is additionally communicatively couplable or coupled (e.g. by way of a network, such as a local area network, such as a wired or wireless local area network) to the vehicle detection camera(s) 102 configured to detect vehicle identifiers in the inbound weigh-in monitoring zone 218-1. In such examples, it may be that the vehicle detection camera(s) 102 are configured to (e.g. repeatedly) transmit data relating to (e.g. indicating e.g. comprising or consisting of) a currently detected vehicle identifier in the inbound weigh-in monitoring zone 218-1 to the weight measurement circuitry 108. In such examples, the weight measurement circuitry 108 may be configured to associate the currently detected vehicle identifier with a corresponding inbound weight data relating to a corresponding weight value measured by the inbound weigh station 210-1 depending on a relative timing between a time of detection of the currently detected vehicle identifier by the vehicle detection camera(s) 102 (or e.g. a time of reception of the data relating thereto by the weight measurement circuitry 108) and a time of reception of said weight value by the weight measurement circuitry 108 from the inbound weight station 210-1 (or e.g. a time of generation of the corresponding inbound weight data by the weight measurement circuitry 108). In such examples, it may be that the weight measurement circuitry 108 is further configured to store, cause storage of, or provide for the storage of, in the storage device(s) 106, said inbound weight data such that it is associated with (e.g. linked to) the currently detected vehicle identifier.

However, it is to be understood that the present disclosure is not so limited and the inbound weight data may be associated with a corresponding vehicle identifier and stored in the storage device(s) 106 such it is associated with (e.g. linked to) said vehicle identifier in any other suitable way.

It may be that inbound weight data relating to (e.g. indicating e.g. comprising or consisting of) a measured weight value outside of a predetermined valid weight range (e.g. a measured weight value less than a predetermined lower weight threshold or e.g. a measured weight value greater than a predetermined upper weight threshold) indicates a vehicle corresponding to the vehicle identifier associated with that inbound weight data to have invalidly performed an inbound weigh-in during the particular visit to the load handling site associated or associable with that load handling data (e.g. by way of traversing the inbound weigh station 210-1 without pausing thereon for performance of an inbound weigh-in or e.g. by way of being invalidly positioned on the inbound weigh station 210-1 during performing of an inbound weigh-in, or otherwise).

### Outbound Weight Data

In various configurations, it may be that the system 100 is configured to generate and store, in the storage device(s) 106, respective outbound weight data. In such examples, it may be that the system 100 further comprises the weight measurement circuitry 108. It may be that each of the respective outbound weight data stored in the storage device(s) 106 relates to (e.g. indicates e.g. comprises or consists of) a weight value measured by the outbound weigh station 210-2 corresponding to a particular vehicle having performed an outbound weigh-in at, or having otherwise traversed the outbound weigh station 210-2 (e.g. without pausing on said weigh station to perform an inbound weigh-in thereat). For example, it may be that said weight value is generated by the outbound weigh station 210-2 as a result of said particular vehicle performing an outbound weigh-in at, or otherwise traversing the outbound weigh station 210-2.

It may be that each of the respective outbound weight data stored in the storage device(s) 106 is associated with (e.g. linked to) a respective vehicle identifier of the vehicle to which that outbound weight data corresponds. Additionally, it may be that each of the respective outbound weight data stored in the storage device(s) 106 is associated (e.g. linked to) or at least associable with a particular visit to the load handling site during which that outbound weight data was generated.

As will be discussed further below, it may be that each of the respective outbound weight data is generated by way of the weight measurement circuitry 108, and that each of the respective outbound weight data is associated with a vehicle identifier of a vehicle to which it corresponds by way of the vehicle detection camera(s) 102.

It may be that the weight measurement circuitry 108 is communicatively couplable or coupled to the outbound weigh station 210-2 and configured to (e.g. repeatedly) receive respective weight measurement values generated by the outbound weigh station 210-2 by way of said communicative coupling therebetween, and to generate respective outbound weight data relating to (e.g. indicating e.g. comprising or consisting of) respective ones of said weight measurement values. It may be that the weight measurement circuitry 108 is configured to (e.g. repeatedly) store, cause storage of, or provide for the storage of, in the storage device(s) 106, each of said respective outbound weight data.

To provide for the association of respective ones of the outbound weight data with respective vehicle identifiers, it may be that the vehicle detection camera(s) 102 are configured to detect respective vehicle identifiers of vehicles present in the outbound weigh-in monitoring zone 218-2. In such examples, it may be that the system 100 is configured to (e.g. repeatedly) associate respective ones of the outbound weight data generated by the weight measurement circuitry 108 and respective vehicles identifiers corresponding to said outbound weight data depending on a relative timing between a time at which said outbound weight data is generated by the weight measurement circuitry 108 (or e.g. a time at which the weight measurement value to which that outbound weight data relates is received by the weight measurement circuitry 108 from the outbound weigh station 210-2) and a time at which said vehicle identifiers are detected in the outbound weigh-in monitoring zone 218-2 by the vehicle detection camera(s) 102.

The system 100 may be configured to associate respective ones of the outbound weight data with respective vehicle identifiers in any suitable way. As an illustrative example, it may be that the weight measurement circuitry 108 is additionally communicatively couplable or coupled (e.g. by way of a network, such as a local area network, such as a wired or wireless local area network) to the vehicle detection camera(s) 102 configured to detect vehicle identifiers in the outbound weigh-in monitoring zone 218-2. In such examples, it may be that the vehicle detection camera(s) 102 are configured to (e.g. repeatedly) transmit data relating to (e.g. indicating e.g. comprising or consisting of) a currently detected vehicle identifier in the outbound weigh-in monitoring zone 218-2 to the weight measurement circuitry 108. In such examples, the weight measurement circuitry 108 may be configured to associate the currently detected vehicle identifier with a corresponding outbound weight data relating to a corresponding weight value measured by the outbound weigh station 210-2 depending on a relative timing between a time of detection of the currently detected vehicle identifier by the vehicle detection camera(s) 102 (or e.g. a time of reception of the data relating thereto by the weight measurement circuitry 108) and a time of reception of said weight value by the weight measurement circuitry 108 from the inbound weight station 210-1 (or e.g. a time of generation of the corresponding outbound weight data by the weight measurement circuitry 108). In such examples, it may be that the weight measurement circuitry 108 is further configured to store, cause storage of, or provide for the storage of, in the storage device(s) 106, said outbound weight data such that it is associated with (e.g. linked to) the currently detected vehicle identifier.

However, it is to be understood that the present disclosure is not so limited and the outbound weight data may be associated with a corresponding vehicle identifier and stored in the storage device(s) 106 such that it is associated with (e.g. linked to) said vehicle identifier in any other suitable way.

It may be that outbound weight data relating to a measured weight value outside of a predetermined valid weight range (e.g. a measured weight value less than a predetermined lower weight threshold or e.g. a measured weight value greater than a predetermined upper weight threshold) indicates a vehicle having the vehicle identifier associated with that outbound weight data to have invalidly performed an outbound weigh-in during the particular visit to the load handling site associated with that load handling data (e.g. by way of traversing the outbound weigh station 210-2 without pausing thereon for performance of an outbound weigh-in or e.g. by way of being invalidly positioned on the outbound weigh station 210-2 during performance of an outbound weigh-in, or otherwise).

In any example disclosed herein, it may be that the weight measurement circuitry 108 comprises any circuitry or circuitries suitable for receiving measured weight values from one or more weigh stations (e.g. such as the inbound weigh station 210-1, the outbound weigh station 210-2, or both) and generating corresponding weight data relating thereto (e.g. such as inbound weight data, outbound weight data, or both). For example, it may be that the weight measurement circuitry 108 comprises one or more weighbridge indicators.

### Vehicle Positioning Data

### Inbound Vehicle Positioning Data

In various configurations, it may be that the system 100 is configured to generate and store, in the storage device(s) 106, respective inbound vehicle positioning data. In such examples, it may be that the system 100 further comprises the vehicle positioning sensor(s) 110. It may be that each of the respective inbound vehicle positioning data relates to (e.g. indicates) whether a particular vehicle was validly positioned during an inbound weigh-in at the inbound weigh station 210-1 during a particular visit to the load handling site.

It may be that each of the respective inbound vehicle positioning data stored in the storage device(s) 106 is associated with (e.g. linked to) a respective vehicle identifier of the vehicle to which that inbound vehicle positioning data corresponds. Additionally, it may be that each of the respective inbound vehicle positioning data stored in the storage device(s) 106 is associated (e.g. linked to) or at least associable with a particular visit to the load handling site during which that inbound vehicle positioning data was generated.

As will be discussed further below, it may be that each of the respective inbound vehicle positioning data is generated by way of the vehicle positioning sensor(s) 110, and that each of the respective inbound vehicle positioning data is associated with a vehicle identifier of a vehicle to which it corresponds by way of the vehicle detection camera(s) 102.

It may be that a vehicle is validly positioned on a weigh station (e.g. such as the inbound weigh station 210-1 or the outbound weigh station 210-2) during performance of a weigh-in (e.g. such as an inbound weigh-in or an outbound weigh-in) thereat when that vehicle is positioned such that its entire weight is supported by a weighing surface of that weigh station. It may be that a vehicle is invalidly positioned on a weigh station when that vehicle is positioned such that only a fraction (i.e. and not an entirety) of its weight is supported by a weighing surface of that weigh station. An example of an invalid vehicle position may be when a vehicle is positioned on a weigh station such that one or more wheels of the vehicle are supported by a surface other than the weighing surface of the weigh station, such as e.g. ground adjacent the weigh station.

The vehicle positioning sensor(s) 110 may be configured to detect invalid vehicle positions of vehicles performing inbound weigh-ins at the inbound weigh station 210-1. It may be that the vehicle positioning sensor(s) 110 are configured to detect such invalid vehicle positions by detecting if a front end or a rear end of a vehicle extends beyond a valid weighing area of the inbound weigh station 210-1 during performance of an inbound weigh-in thereat. For example, it may be that the vehicle positions sensor(s) 110 comprise: one or more first sensors configured to detect if a front end of a vehicle extends beyond a valid weighing area of the inbound weigh-station 210-1; and one or more second sensors configured to detect if a rear end of a vehicle extends beyond the valid weighing area of the inbound weigh station 210-1.

The vehicle positioning sensor(s) 110 may comprise any suitable number of sensors and any suitable type of sensor for detecting a position of a vehicle on a weigh station (e.g. for detecting whether one or both of a front end and a rear end of vehicle extends beyond a valid weighing area of a weigh station). For example, the vehicle positioning sensor(s) 110 may comprise one or more photoelectric sensors, including but not limited to any combination of through beam sensor(s), retro-reflective sensor(s), diffuse sensor(s). Additionally or alternatively, the vehicle positions sensor(s) 110 may comprise one or more pressure sensors. Additionally or alternatively, the vehicle position vehicle positioning sensor(s) 110 may comprise one or more ultrasonic sensors, such as one or more ultrasonic proximity sensors. Additionally or alternatively, the vehicle positioning sensor(s) 110 may comprise one or more cameras and associated processing circuitry configured to determine invalid vehicle positions at the inbound weigh station 210-1.

It may be that the vehicle positioning sensor(s) 110 are communicatively couplable or coupled to the storage device(s) 106 (e.g. directly or e.g. by way of intervening circuitry such as the weight measurement circuitry 108 or any other suitable circuitry) and are configured to (e.g. repeatedly) generate (or e.g. provide signaling providing for the generation of) respective inbound vehicle positioning data relating to (e.g. indicating) a validity of a vehicle position at the inbound weigh station 210-1 of a vehicle corresponding to the vehicle identifier with which the inbound vehicle positioning data is associated. For example, it may be that each of the respective inbound vehicle positioning data indicates a validity of a positioning of said vehicle during an inbound weigh-in at the inbound weigh station 210-1 e.g. by way of indicating whether one or both of a front end or a rear end of said vehicle was detected outside of a valid weighing area of the inbound weigh station 210-1 during performance of said inbound weigh-in.

To provide for the association of respective ones of the inbound vehicle positioning data with respective vehicle identifiers to which they correspond, it may be that the vehicle detection camera(s) 102 are configured to detect respective vehicle identifiers of vehicles present in the inbound weigh-in monitoring zone 218-1. In such examples, it may be that the system 100 is configured to (e.g. repeatedly) associate respective ones of the inbound vehicle positioning data and respective vehicles identifiers corresponding to said inbound vehicle positioning data depending on a relative timing between a time at which said inbound vehicle positioning data is generated and a time at which said vehicle identifiers are detected in the inbound weigh-in monitoring zone 218-1 by the vehicle detection camera(s) 102.

The system 100 may be configured to associate respective ones of the inbound vehicle positioning data with respective vehicle identifiers in any suitable way. As an illustrative example, it may be that the processing circuitry (e.g. such as the weight measurement circuitry 108, or any other suitable processing circuitry) is communicatively couplable or coupled (e.g. by way of a network, such as a local area network, such as a wired or wireless local area network) to each of the vehicle positioning sensor(s) 110 and the vehicle detection camera(s). In such examples, it may be that said processing circuitry is configured to (e.g. repeatedly) receive current inbound vehicle positioning data from the vehicle positioning sensor(s) 110, and to (e.g. repeatedly) receive data relating to a currently detected vehicle identifier in the inbound weigh-in monitoring zone 218-1 from the vehicle detection camera(s) 110. In such examples, the processing circuitry may be configured to associate the currently detected vehicle identifier and the current inbound vehicle positioning data and to store, cause storage of, or provide for the storage of, in the storage device(s) 106, said inbound vehicle positioning data such that it is associated with (e.g. linked to) the currently detected vehicle identifier.

However, it is to be understood that the present disclosure is not so limited and the inbound vehicle positioning data may be generated by the system 100 in any other suitable way.

### Outbound Vehicle Positioning Data

In various configurations, it may be that the system 100 is configured to generate and store, in the storage device(s) 106, respective outbound vehicle positioning data. In such examples, it may be that the system 100 comprises the vehicle positioning sensor(s) 110. It may be that each of the respective outbound vehicle positioning data relates to (e.g. indicates) whether a particular vehicle was validly positioned during an outbound weigh-in at the outbound weigh station 210-2 during a particular visit to the load handling site.

It may be that each of the respective outbound vehicle positioning data stored in the storage device(s) 106 is associated with (e.g. linked to) a respective vehicle identifier of the vehicle to which that outbound vehicle positioning data corresponds. Additionally, it may be that each of the respective outbound vehicle positioning data stored in the storage device(s) 106 is associated (e.g. linked to) or at least associable with and a particular visit to the load handling site during which that outbound vehicle positioning data was generated.

As will be discussed further below, it may be that each of the respective outbound vehicle positioning data is generated by way of the vehicle positioning sensor(s) 110, and that each of the respective outbound vehicle positioning data is associated with a vehicle identifier of a vehicle to which it corresponds by way of the vehicle detection camera(s) 102.

The vehicle positioning sensor(s) 110 may be configured to detect invalid vehicle positions of vehicles performing outbound weigh-ins at the outbound weigh station 210-2. It may be that the vehicle positioning sensor(s) 110 are configured to detect such invalid vehicle positions by detecting if a front end or a rear end of a vehicle extends beyond a valid weighing area of the outbound weigh station 210-2 during performance of an outbound weigh-in thereat. For example, it may be that the vehicle positions sensor(s) 110 comprise: one or more first sensors configured to detect if a front end of a vehicle extends beyond a valid weighing area of the outbound weigh-station 210-2; and one or more second sensors configured to detect if a rear end of a vehicle extends beyond the valid weighing area of the outbound weigh station 210-1.

The vehicle positioning sensor(s) 110 may comprise any suitable number of sensors and any suitable type of sensor for detecting a validity of a position of a vehicle on the outbound weigh station 210-2 (e.g. for detecting whether one or both of a front end and a rear end of vehicle extends beyond a valid weighing area of the outbound weigh station 210-1), including but not limited to any one or more the types of vehicle positioning sensors disclosed herein.

It may be that the vehicle positioning sensor(s) 110 are communicatively couplable or coupled to the storage device(s) 106 (e.g. directly or e.g. by way of intervening circuitry such as the weight measurement circuitry 108 or any other suitable circuitry) and are configured to (e.g. repeatedly) generate (or e.g. provide signaling providing for the generation of) respective outbound vehicle positioning data relating to (e.g. indicating) a validity of a vehicle position at the outbound weigh station 210-2 of a vehicle corresponding to the vehicle identifier with which the outbound vehicle positioning data is associated. For example, it may be that each of the respective outbound vehicle positioning data indicates a validity of a positioning of said vehicle during an outbound weigh-in at the outbound weigh station 210-1 e.g. by way of indicating whether one or both of a front end or a rear end of said vehicle was detected outside of a valid weighing area of the outbound weigh station 210-2 during performance of said outbound weigh-in.

To provide for the association of respective ones of the outbound vehicle positioning data with respective vehicle identifiers to which they correspond, it may be that the vehicle detection camera(s) 102 are configured to detect respective vehicle identifiers of vehicles present in the outbound weigh-in monitoring zone 218-2. In such examples, it may be that the system 100 is configured to (e.g. repeatedly) associate respective ones of the outbound weight data generated by the weight measurement circuitry 108 and respective vehicles identifiers corresponding to said outbound vehicle positioning data depending on a relative timing between a time at which said outbound vehicle positioning data is generated and a time at which said vehicle identifiers are detected in the outbound weigh-in monitoring zone 218-2 by the vehicle detection camera(s) 102.

The system 100 may be configured to associate respective ones of the outbound vehicle positioning data with respective vehicle identifiers in any suitable way. For example, the system 100 may be configured to associate respective ones of the outbound vehicle positioning data with respective vehicle identifiers in similar or same way to that described for associating inbound vehicle positioning data and corresponding vehicle identifiers.

### Load Type Data

It may be that the system 100 is further configured to generate and to store, in the storage device(s) 106, respective load type data relating to (e.g. indicating) whether a load carried by a respective vehicle during a visit to the load handling site is radioactive (e.g. emits radiation above a (e.g. predetermined) radioactivity threshold). In such examples, the system 100 may further comprise the radiation detector(s) 112. The radiation detectors 112 may comprise any number of any suitable type of radiation detectors, including but not limited to one or more gas ionization based detectors, one or more scintillation based detectors, one or more semiconductor detectors, or combinations thereof.

It may be that each of the respective load type data stored in the storage device(s) 106 is associated with (e.g. linked to) a respective vehicle identifier of the vehicle to which that load type data corresponds. Additionally, it may be that each of the respective load type data stored in the storage device(s) 106 is associated (e.g. linked to) or at least associable with a particular visit to the load handling site during which that load type data was generated.

As will be discussed further below, it may be that each of the respective load type data is generated by way of the radiation detector(s) 110, and that each of the respective load type data is associated with a vehicle identifier of a vehicle to which it corresponds by way of the vehicle detection camera(s) 102.

The radiation detector(s) 112 may be configured to detect respective radioactivity levels of vehicles present in at least one area of the load handling site. For the sake of brevity, the following assumes that the radiation detector(s) 112 are configured to detect respective radioactivity levels of vehicles at the inbound weigh station 212-1 and that the system 100 is to provide for the association of respective load type data with respective vehicle identifiers by way the vehicle detection camera(s) 102 being configured to detect respective vehicle identifiers of vehicles present in the inbound weigh-in monitoring zone 218-1. However, it is to be understood that the present disclosure is not so limited and the radiation detector(s) 112 may be configured to detect respective radioactivity levels of vehicles in any one or more other areas of the load handling site. In such examples, the system 100 may provide for the association of respective load type data with respective vehicle identifiers by way the vehicle detection camera(s) 102 being configured to detect respective vehicle identifiers of vehicles present in a monitoring zone or zones corresponding to said one or more other areas of the load handling site.

It may be that the radiation detector(s) 110 are communicatively couplable or coupled to the storage device(s) 106 (e.g. directly or e.g. by way of intervening circuitry such as the weight measurement circuitry 108 or any other suitable circuitry) and are configured to (e.g. repeatedly) generate (or e.g. provide signaling providing for the generation of) respective load type data relating to (e.g. indicating e.g. comprising or consisting of) detected radioactivity levels at the inbound weigh station 210-1 corresponding to a vehicle having the vehicle identifier with which the load type data is associated.

As mentioned above, to provide for the association of respective ones of the load type data with respective vehicle identifiers to which they correspond, it may be that the vehicle detection camera(s) 102 are configured to detect respective vehicle identifiers of vehicles present in the inbound weigh-in monitoring zone 218-1. In such examples, it may be that the system 100 is configured to (e.g. repeatedly) associate respective ones of the load type data and respective vehicles identifiers corresponding to said load type data depending on a relative timing between a time at which said load type data is generated and a time at which said vehicle identifiers are detected in the inbound weigh-in monitoring zone 218-1 by the vehicle detection camera(s) 102.

The system 100 may be configured to associate respective ones of the load type data with respective vehicle identifiers in any suitable way. For example, the system 100 may be configured to associate respective ones of the load data with respective vehicle identifiers in a similar or same way to the that described for associating inbound or outbound vehicle positioning data and corresponding vehicle identifiers.

It is to be understood that any type of data disclosed herein described as being stored in the storage device(s) 106 and associated (e.g. linked to) or at least associable (i.e. capable of being associated with) with a particular visit to the load handling site (e.g. such as load handling data, inbound or outbound bypass zone data, inbound or outbound weigh-in zone data, inbound or outbound weight data, inbound or outbound vehicle positioning data, or load type data) may be stored in the storage device(s) 106 such that that data is associated or at least associable with the particular visit to the load handling site in any suitable way, and at least to the extent that that data is matchable to other relevant data associated or associable with the same particular visit to the load handling site. Accordingly, where one more data stored in the storage device(s) 106 are associated with the same vehicle identifier and are further associated or associable with the same particular visit, it may be determinable that each of said one or more data corresponds to the same vehicle identifier and the same particular visit.

It is to be understood that data described as being associated or associable with a particular visit to the load handling site does not necessarily mean that that data indicates e.g. a particular temporal period extending from a time at which a corresponding vehicle entered the load handling site to the next time at which that vehicle exited the load handling site. It may be that said data stored in the storage device(s) 106 is merely matchable to other relevant data associated or associable with the same visit. For example, it may be that one some, or each of any data described herein as being associated or associable with a particular visit comprises respective visit data relating to (e.g. identifying or e.g. indicating e.g. a time falling within) the particular visit to the load handling site with which that data is associated or associable. It may be that said visit data relates to (e.g. indicates e.g. comprises or consists of) a timestamp (e.g. a time and a date) associated with (e.g. falling within) a temporal period of a visit to the load handling site with which that data is associated. In such examples, it may be that such (e.g. first) data comprising said visit data is matched or matchable to one or more other (e.g. second) data associated with the same vehicle identifier and associated or associable with the same particular visit on the basis of (i.e. depending on) that second data indicating or comprising a respective timestamp corresponding to a time that is within a predetermined temporal distance of a time corresponding to the timestamp of the visit data of the first data.

In the case of load handling data, it may be that such visit data relates to a timestamp corresponding to a time and a date at which the vehicle identifier associated with that load handling data was detected by the vehicle detection camera(s) 102 in the load handling monitoring zone 214.

In the case of inbound or outbound bypass zone data, it may be that such visit data relates to a timestamp corresponding to a time and a date at which the vehicle identifier associated with that bypass zone data was detected by the vehicle detection camera(s) 102 in the inbound or the outbound bypass monitoring zone.

In the case of inbound or outbound weigh-in zone data, it may be that such visit data relates to a timestamp corresponding to a time and a date at which the vehicle identifier associated with that weigh-in zone data was detected by the vehicle detection camera(s) 102 in the inbound or the outbound weigh-in monitoring zone.

In the case of inbound or outbound weight data, it may be that such visit data relates to a timestamp corresponding to: a time and a date at which the vehicle identifier associated with that weight data was detected by the vehicle detection camera(s) 102 in the inbound or the outbound weigh-in monitoring zone; or a time and a date at which that weight data was generated by the weight measurement circuitry 108.

In the case of inbound or outbound vehicle positioning data, it may be that such visit data relates to a time stamp corresponding to: a time and a date at which the vehicle identifier associated with that vehicle positioning data was detected by the vehicle detection camera(s) 102 in the inbound or outbound weigh-in monitoring zone; or a time and a date at which that vehicle positioning data was generated.

In the case of load type data, it may that said visit data relates to: a time and a date at which the vehicle identifier associated with that load type data was detected by the vehicle detection camera(s) 102 in a corresponding monitoring zone (e.g. such as the inbound weigh-in monitoring zone); or a timestamp corresponding to a time and a date at which that load type data was generated.

Additionally or alternatively, it may be that one, some, or each of any data disclosed herein as being stored in the storage device(s) 106 such that that data is associated with a particular vehicle identifier and a particular visit to the load handling site does not comprise respective visit data. In such examples, it may be that one, some, or each of said data is associated with a particular visit to the load handling site in any other suitable way. For example, it may be that one, some, or each of said data is associated with a particular visit to the load handling site by the mere presence of that data in the storage device(s) 106. For example, it may be that the system 100 is configured to store in the storage device(s) 106 (or e.g. in a predetermined location or locations thereof or e.g. in a predetermined location or locations within a database stored in the device(s) 106) such data relating only to most recent visits by vehicles to the load handling site (e.g. by way of repeatedly purging older data). Accordingly, it may be implicit, and therefore determinable (e.g. by the compliance indicator 104), that any such data stored in the (e.g. predetermined location or locations of the) storage device(s) (or e.g. database stored therein)) 106 associated with the same vehicle identifier are also associated with the same (most recent) visit to the load handling site.

### Non-Compliance Notification

Referring now to the compliance indicator 104 of the system 100, the compliance indicator 104 may be configured to determine whether to, and to correspondingly generate, a notification indicating a given vehicle to have not complied with the load handling procedure during a particular visit by that vehicle to the load handling site depending on data (which may be referred to as “vehicle data”) obtained by the compliance indicator 104 indicating: whether a vehicle identifier of the given vehicle was detected in the load handling monitoring zone 214 during the particular visit; and whether the given vehicle performed at least one action at the load handling site during the visit.

The at least one action may comprise any action which, depending on whether a vehicle identifier of a given vehicle was detected in the load handling monitoring zone, may indicate non-compliance with load handling procedure by that vehicle. For example, the at least one action may comprise at least one non-compliant action, such as one or more of: bypassing an inbound weigh-in; bypassing an outbound weigh-in; invalidly performing an inbound weigh-in; invalidly performing an outbound weigh-in; carrying a radioactive load. Additionally or alternatively, the at least one action may comprise any other action, such as, for example, a vehicle entering a monitoring zone (e.g. such as the inbound or outbound weigh-in monitoring zone), which may in indicate anomalous and potentially non-compliant behavior by that vehicle in the case where that that vehicle is not detected in the load handling monitoring zone during the same visit.

The vehicle data may depend on (e.g. a presence or absence of) data stored in the storage device(s) 106 associated with a vehicle identifier of the given vehicle and corresponding to the particular visit (i.e. being associated or associable with the given visit). Such data may comprise, for example, any one or more of: load handling data associated said vehicle identifier and corresponding to said visit; inbound or outbound bypass zone data associated with said vehicle identifier and corresponding to said visit; inbound or outbound weigh-in zone data associated with said vehicle identifier and corresponding to said visit; inbound or outbound weight data associated with said vehicle identifier and corresponding to said visit; inbound or outbound vehicle positioning data associated with said vehicle identifier and corresponding to said visit; load type data associated said vehicle identifier and corresponding to said visit.

As will be discussed further below, it may be that the vehicle data is indicative of a presence or absence of any one or more of the above-mentioned data in the storage device(s) 106 associated with the vehicle identifier of the given vehicle and corresponding to the particular visit. For example, it may be that the vehicle data obtained by the compliance indictor 104 comprises an indication of the presence or absence of such data in the storage device(s) (e.g. which may be received from intervening circuitry e.g. such as processing circuitry implementing a database controller controlling a database storing the above-mentioned data in the storage device(s) 106 (not shown), or any other processing circuitry). Alternatively, it may be that the vehicle data obtained by compliance indicator 104 comprises any one or more of the following data (e.g. if the system 100 is configured to generate that data, and if that data is present in the storage device(s) 106): load handling data associated said vehicle identifier and corresponding to said visit; inbound or outbound bypass zone data associated with said vehicle identifier and corresponding to said visit; inbound or outbound weigh-in zone data associated with said vehicle identifier and corresponding to said visit; inbound or outbound weight data associated with said vehicle identifier and corresponding to said visit; inbound or outbound vehicle positioning data associated with said vehicle identifier and corresponding to said visit; load type data associated said vehicle identifier and corresponding to said visit. In this case, it may be that the vehicle data is obtained by the compliance indicator by way of receiving the vehicle data from the storage device(s) 106.

The vehicle data obtained by the compliance indicator 104 may be obtained in any suitable way. Furthermore, it may be that any constituent data comprised within said vehicle data (e.g. such as data indicating whether a vehicle identifier was detected in a load handling monitoring zone of the load handling site during a visit thereto by a corresponding vehicle or e.g. one more data indicating whether that vehicle performed at least one action at the load handling site during said visit) may be obtained in any suitable order.

As an illustrative example, it may be that the compliance indicator 104 is configured to first obtain data indicating that a vehicle identifier was detected in the load handling monitoring zone 214 during a particular visit thereto by a corresponding vehicle. For example, it may be that the system 100 is configured to (e.g. repeatedly) push newly stored instances of load handling data (or indications thereof) in the storage device(s) 106 to the compliance indicator 104. Alternatively, it may be that the compliance indicator 104 is configured to (e.g. repeatedly) search for and thereby receive newly stored instances of load handling data in the storage device(s) 106. It may be that, subsequent to having first obtained such data, the compliance indicator 104 is configured to determine whether one or more further data associated with the same vehicle identifier and corresponding to the same particular visit (such as e.g. inbound or outbound bypass zone data, inbound our outbound weigh-in zone data, inbound or outbound vehicle positioning data, load type data, or combinations thereof) are present or absent in the storage device(s) 106.

In such examples, the compliance indicator may be configured to determine a presence or absence of such further data associated with the same vehicle identifier and the same particular visit in any suitable way. For example, in the case of first obtaining data indicating that a vehicle identifier was detected in the load handling monitoring zone, the compliance indicator 104 may be configured to determine whether any one or more earlier data associated with the same vehicle identifier and corresponding to the same visit as that load handling data (e.g. such as inbound data such as e.g. any one or more of inbound bypass zone data, inbound weigh-in zone data, inbound weight data, load type data (e.g. depending on a position of the radiation detector(s) 112, when present)) are present in the storage device(s) 106 (e.g. by searching the storage device(s) 106 e.g. by querying a database configured to store said inbound data in the storage device(s) 106, or otherwise) at any time after having first obtained the data indicating that the vehicle identifier was detected in the load handling monitoring zone 214. Additionally or alternatively, the compliance indicator 104 may be configured to determine whether any one or more later data associated with the same vehicle identifier and corresponding to the same visit as that load handling data (e.g. such as outbound data such as e.g. any one or more of outbound bypass zone data, outbound weigh-in zone data, outbound weight data, load type data (e.g. depending on a position of the radiation detector(s) 112, when present)) is present in the storage device(s) 106 (e.g. by searching the storage device(s) 106 e.g. by querying a database configured to store said inbound data in the storage device(s) 106, or otherwise) after at least a predetermined temporal period to allow for such later data to be generated and stored. It may be that the compliance indicator 104 is configured to determine that such later data is absent if the compliance indicator 104 determines that such data is not stored in the storage device(s) 106 after said predetermined temporal period.

However, it is to be understood that the present disclosure is not so limited and the compliance indicator 104 may be alternatively configured to obtain the vehicle data and constituent data thereof in any other way and in any order. For example, the compliance indicator 104 may be configured to first obtain inbound data (e.g. such as any one or more inbound data disclosed herein) and to subsequently determine whether any one or more later data associated with the same vehicle identifier and corresponding to the same particular visit (e.g. such as any one or more of: load handling data; outbound bypass zone data, outbound weigh-in zone data, outbound weight data, load type data (e.g. depending on a position of the radiation detector(s) 112, when present)) are present or absent in the storage device(s) 106 after a predetermined temporal period to allow for the generation and storage of such data. Alternatively, the compliance indicator 104 may be configured to first obtain outbound data (e.g. such as any one or more outbound data disclosed herein) and to subsequently determine whether any one or more earlier data associated with the same vehicle identifier and corresponding to the same particular visit (e.g. such as any one or more of: load handling data; inbound bypass zone data, inbound weigh-in zone data, inbound weight data, load type data (e.g. depending on a position of the radiation detector(s) 112, when present)) are present or absent in the storage device(s) 106 at any time having first obtained said outbound data.

That any two or more data in the storage device(s) 106 associated with the same vehicle identifier correspond to the same particular visit to the load handling site may be determined (e.g. by compliance indicator 104, or by any other circuitry through which the compliance indicator may obtain the vehicle data) in any suitable way. For example, it may be that such data comprise respective visit data, in accordance with examples disclosed herein. In such examples, it may be determined that any two or more data associated with the same vehicle identifier corresponds to the same visit depending on their respective visit data. For example, it may be determined that any two or more data associated with the same vehicle identifier correspond to the same visit when said data comprises respective visit data relating to respective timestamps corresponding to respective times which are within a predetermined temporal distance of each other. For example it may be determined that a given load handling data associated with a given vehicle identifier corresponds to the same visit as one or more inbound data associated with the same vehicle identifier (e.g. such as any one or more inbound data disclosed herein, including load type data (e.g. depending on a position of the radiation detector(s) 112, when present)) when said load handling data and said inbound data comprise respective visit data relating to respective timestamps, wherein a time corresponding to the timestamp of the load handling data is within a predetermined temporal period subsequent to a time corresponding to the timestamp of the inbound data. Additionally or alternatively, it may be determined that a given load handling data associated with a given vehicle identifier corresponds to the same visit as one or more outbound data associated with the same vehicle identifier (e.g. such as any one or more outbound data disclosed herein, including load type data (e.g. depending on a position of the radiation detector(s) 112, when present)) when said load handling data and said outbound data comprise respective visit data relating to respective timestamps, wherein a time corresponding to the timestamp of the load handling data is within a predetermined temporal period prior to a time corresponding to the timestamp of the inbound data.

However, it is to be understood that the present disclosure is not so limited, and that any two or more data in the storage device(s) 106 associated with the same vehicle identifier may be determined to correspond to the same particular visit to the load handling site in any other suitable way, such as depending on the mere presence of that data in (e.g. a predetermined location or locations of) the storage device(s) 10 (or in a database stored in the storage device(s) 106), or otherwise.

In examples wherein the system 100 is configured to generate and store inbound or outbound bypass zone data, it may be that the compliance indicator 104 is configured to determine to generate a notification indicating a given vehicle to have not complied with the load handling procedure during a particular visit to the load handling site by that vehicle when vehicle data obtained by the compliance indicator 104 indicates that: a vehicle identifier of said vehicle was detected in the load handling monitoring zone 214 during said visit (e.g. by way of indicating a presence of load handling data associated with said vehicle identifier and corresponding to said visit); and said vehicle identifier was detected in one or both of the inbound and outbound bypass monitoring zones during said visit (e.g. by way of indicating a presence of one or both of inbound and outbound bypass monitoring zone data associated with said vehicle identifier and corresponding to said visit).

For example, it may be that the compliance indicator 104 is configured to determine to generate said notification when: the vehicle data indicates that said vehicle identifier of said vehicle was detected in the load handling monitoring zone 214; and when the vehicle data further indicates that said vehicle identifier was detected in the inbound (or outbound) bypass monitoring zone within a predetermined temporal period prior (subsequent) to a time at which said vehicle identifier was detected in the load handling monitoring zone 214 (which e.g. may be indicated by way of indicating respective timestamps of respective visit data of such data).

Additionally or alternatively, in examples wherein the system 100 is configured to generate and store inbound or outbound weigh-in zone data, it may be that the compliance indicator 104 is configured to determine to generate a notification indicating the given vehicle to have not complied with the load handling procedure during the particular visit to the load handling site by that vehicle when vehicle data obtained by the compliance indicator 104 indicates that: the vehicle identifier of the vehicle was detected in the load handling monitoring zone 214 during said visit; and said vehicle identifier was not detected in at least one weigh-in monitoring zone of the load handling site during said visit (e.g. which may be indicated by way of indicating an absence of one or both of inbound and outbound weigh-in zone data associated with said vehicle identifier and corresponding to said visit).

For example, it may be that the compliance indicator 104 is configured to determine to generate said notification when: the vehicle data indicates that said vehicle identifier was detected in the load handling monitoring zone 214; and when the vehicle data further indicates that said vehicle identifier was not detected in the inbound (or outbound) bypass monitoring zone within a predetermined temporal period prior (subsequent) to a time at which said vehicle identifier was detected in the load handling monitoring zone 214 (which e.g. may be indicated by way of indicating respective timestamps of respective visit data of such data).

Additionally or alternatively, in examples wherein the system 100 is configured to generate and store inbound or outbound weight data, it may be that the compliance indicator 104 is configured to determine to generate a notification indicating a given vehicle to have not complied with the load handling procedure during a particular visit to the load handling site by that vehicle when vehicle data obtained by the compliance indicator 104 indicates that: a vehicle identifier of said vehicle was detected in the load handling monitoring zone 214; and when the vehicle data further indicates at least one measured weight value corresponding to said vehicle (e.g. such as a measured weight value of inbound weight data, a measured weight value of outbound weight data, or both) to be outside of a predetermined valid weight range (e.g. which may be indicated by way of indicating a presence of one or both of inbound and outbound weight data associated with said vehicle identifier and corresponding to said visit and relating to (e.g. indicating e.g. comprising or consisting of) one or more measured weight values outside of a predetermined valid weight range).

For example, it may be that the compliance indicator 104 is configured to determine to generate said notification when the vehicle data indicates that said vehicle identifier of said vehicle was detected in the load handling monitoring zone 214; and when the vehicle data further indicates that the inbound (or outbound) weight data corresponds to a weigh-in performed within a predetermined temporal period prior (subsequent) to a time at which said vehicle identifier was detected in the load handling monitoring zone 214 (which e.g. may be indicated by way of indicating respective timestamps of respective visit data of such data).

Alternatively, the system 100 may be configured to generate said notification when the vehicle data indicates at least one measured weight value corresponding to the vehicle (e.g. such as a measured weight value of inbound weight data, a measured weight value of outbound weight data, or both) to be outside of a predetermined valid weight range irrespective of whether the vehicle data additionally indicates that the vehicle identifier of that vehicle was detected in the load handling monitoring zone 214.

Additionally or alternatively, in examples wherein the system 100 is configured to generate and store inbound or outbound vehicle positioning data, it may be that the compliance indicator 104 is configured determine to generate a notification indicating a given vehicle to have not complied with the load handling procedure during a particular visit to the load handling site by that vehicle when vehicle data obtained by the compliance indicator 104 indicates that the vehicle identifier of the vehicle was detected in the load handling monitoring zone of the load handling site during the visit, and the data further indicates the vehicle to have been invalidly positioned during at least one weigh-in during the visit (e.g. which may be indicated by way of indicating a presence of one or both of inbound and outbound vehicle positioning data associated with said vehicle and corresponding to said visit and relating to the vehicle having been invalidly positioned during a weigh-in (e.g. such as an inbound or an outbound weigh-in)).

For example, it may be that the compliance indicator 104 is configured to determine to generate said notification when the vehicle data indicates that said vehicle identifier of said vehicle was detected in the load handling monitoring zone 214; and when the vehicle data further indicates that said vehicle positioning data corresponds to a an inbound (or outbound) weigh-in performed within a predetermined temporal period prior (subsequent) to a time at which said vehicle identifier was detected in the load handling monitoring zone 214. (which e.g. may be indicated by way of indicating respective timestamps of respective visit data of such data).

Alternatively, the system 100 may be configured to generate said notification when the vehicle data indicates the vehicle to have been invalidly positioned during at least one weigh-in during the visit irrespective of whether the vehicle data additionally indicates that the vehicle identifier of the vehicle was detected in the load handling monitoring zone 214.

Additionally or alternatively, in examples wherein the system 100 is configured to generate and store load type data, it may be that the compliance indicator 104 is configured to determine to generate a notification indicating a given vehicle to have not complied with the load handling procedure during a particular visit to the load handling site by that vehicle when vehicle data obtained by the compliance indicator 104 indicates that the vehicle identifier of the vehicle was detected in the load handling monitoring zone 214, and the vehicle data further indicates the vehicle to have been carrying a radioactive load during the visit (e.g. which may be indicated by way of indicating a presence of load type data associated with the vehicle and corresponding to the visit and relating to (e.g. indicating e.g. comprising or consisting of) a detected radioactivity level contravening (e.g. exceeding) a predetermined radioactivity threshold.

For example, it may be that the compliance indicator 104 is configured to determine to generate said notification when the vehicle data indicates that said vehicle identifier of said vehicle was detected in the load handling monitoring zone 214; and when the vehicle data further indicates that said load type data corresponds to a radioactivity detection performed within a predetermined temporal period (e.g. prior or subsequent to, depending on a position of the radiation detector(s) 112) to a time at which said vehicle identifier was detected in the load handling monitoring zone 214 (which e.g. may be indicated by way of indicating respective timestamps of respective visit data of such data).

Alternatively, the system 100 may be configured to generate said notification when the vehicle data indicates a presence of such load type data irrespective of whether the vehicle data additionally indicates that the vehicle identifier of the vehicle was detected in the load handling monitoring zone 214.

Additionally or alternatively, it may be that the compliance indicator 104 is configured to generate a notification indicating a given vehicle to have not complied with the load handling procedure during a particular visit to the load handling site by that vehicle when vehicle data obtained by the compliance indicator 104 indicates the vehicle identifier of the vehicle to not have been detected in the load handling monitoring zone of the load handling site during the visit ((e.g. by way of indicating an absence of load handling data associated with said vehicle identifier and corresponding to said visit)); and the data further the vehicle to have been detected in at least other monitoring zone of the load handling site during the visit (such as e.g. any one or more of: the inbound or outbound bypass monitoring zone; the inbound or outbound weigh-in monitoring zone, or any other zone(s)).

In examples wherein the compliance indictor 104 determines to, and generates the above-discussed notification, it may be that the compliance indicator 104 is configured to provide or cause provision of the generated notification (e.g. in real time) to one or more (e.g. authorised) users or user accounts thereof.

For example, it may be that the compliance indictor 104 is configured to email the generated notification to one or email accounts of the one or more users (e.g. in real time). For example, it may be that the system 100 further comprises the one or more electronic devices 114, which may include one or more emails servers e.g. hosting respective email accounts of the one or more users. In such examples, it may be that the compliance indicator 104 is configured to email the generated notification to the one or email addresses of the one or more users by way of transmitting the notification to the one or more email servers (e.g. in real time).

Additionally or alternatively, it may be that the compliance indictor 104 is configured to provide or cause provision of the generated notification to one or more electronic devices of tone or more users. For example, it may be that the system 100 comprises the one or more electronic devices 114, which may include one or more user devices such as one or more mobile (cell) telephones of the one or more users. In such examples, it may be that the compliance indicator 104 is configured to provide the generated notification to the one or more mobile (cell) telephones) by way of transmitting the notification thereto (e.g. by way of text message, or otherwise).

Additionally or alternatively, it may be that the compliance indictor 104 is configured to provide or cause provision of the generate notification to an online portal or to a web application accessible by one or more users e.g. by way of respective user accounts. In such examples, it may be that the system 100 comprises the one or more electronic devices 114, which may include one or more servers hosting said online portal or web application. In such examples, it may be that the compliance indicator 104 is configured to provide the generated notification to the online portal or web application by way of transmitting the notification to said one or more servers.

It may be that the notification generated by the compliance indicator 104 indicates (e.g. comprises) one or both of: the vehicle identifier of the vehicle to which the notification relates; and an indication of the corresponding visit (e.g. an indication of at least a portion of the temporal period corresponding to that e.g. a time and date associated with (e.g. falling within) that temporal period).

It may be that one, some, or each of the vehicle detection camera(s) 102 are further configured to (e.g. repeatedly) store or to cause storage of, in storage device(s) 106, respective capture data. It may be that each of the respective capture data comprises image(s) or video captured by the corresponding camera relating to a detection instance of a vehicle identifier in a zone of the load handling site in which that camera is to detect vehicle identifiers, such as any one or more of: the load handling monitoring zone 214, the inbound bypass monitoring zone 216-1, the inbound weigh-in monitoring zone 218-1, the outbound bypass monitoring zone 216-2, the outbound weigh-in monitoring zone 218-2. It may be that said image(s) or video are timestamped with a time and a date at which they were captured by the vehicle detection camera(s) 102. It may be that each of the respective capture data is stored in the storage device(s) 106 such that it is associated with (e.g. linked to) a vehicle identifier and further associated or associable with a particular visit to the load handling site by a vehicle to which that capture data relates (e.g. by way of respective visit data, or otherwise). It may be that the system 100 (e.g. the compliance indicator 104 thereof) is to further include capture data associated with the vehicle and the visit in the generated notification. For example, it may be that the notification generated by the compliance indicator 104 and provided to one or more users further includes capture data associated with the vehicle and corresponding to visit to which that notification relates i.e. further includes captured images or video (e.g. which may be retrieved from the storage devices by the compliance indicator 104) corresponding to detection instances of the vehicle identifier of said vehicle in any one or more of: the load handling monitoring zone 214, the inbound bypass monitoring zone 216-1, the inbound weigh-in monitoring zone 218-1, the outbound bypass monitoring zone 216-2, the outbound weigh-in monitoring zone 218-2. Advantageously, providing capture data associated with a vehicle and a particular visit to one or more users or user accounts thereof in this way may provide evidence to support a (e.g. fraud) investigation into that vehicle in the case that it did not to comply with the load handling procedure during that visit.

It may be that the load handling site comprises one or more barriers (not shown) operable to selectively move between an open position and a closed position to thereby selectively block access to and from any one or more of: the site entrance; the site exit; the inbound weigh station lane; the inbound bypass lane; the outbound weigh station lane; the outbound bypass lane. In such examples, the compliance indicator 104 may be further configured to lock or cause the locking of any one or more of said barriers in their closed position (e.g. by way of signaling to an electronically controllable lock of said barriers communicatively couplable or coupled to the compliance indicator 104) responsive to the generation of non-compliance notification. Advantageously, locking any or more of said barriers in this way may at least temporarily trap the corresponding vehicle at the load handling site to allow for further investigation into their potentially fraudulent activity without said vehicle escaping.

While the load handling site shown in FIG. 2 comprises inbound and outbound bypass lanes, and inbound and outbound weigh stations, it is to be understood that the present disclosure is not so limited, and that the system 100 may be implemented at load handling sites comprising: any number of bypass lanes, including but not limited to a single bypass lane; any number of weigh station lanes, including but not limited to a single weigh station lane; and any number of weigh stations, including but not limited to a single weigh station. In such examples, it may be that system 100 is configured accordingly. As an illustrative example, in examples wherein a load handling site comprises a single weigh station for performing both inbound and outbound weigh-ins, it may be that the inbound weigh-in monitoring zone and the outbound weigh-in monitoring zone are one of the same.

Similarly, while the load handling site shown in FIG. 2 comprises a single load handling zone 206, it is to be understood that the present disclosure is not so limited, and that the system 100 may be implemented at load handling sites comprising any number of load handling zones, such as two or more load handling zones. In such examples, it may the system 100 may be configured accordingly. For example, it may be that that the load handling monitoring zone is one a of plurality of load handling monitoring zones configured to provide for the detection of vehicle identifiers at each of the plurality of load handling zones.

While each of the load handling monitoring zone 214, the inbound bypass monitoring zone 216-1, the outbound bypass monitoring zone 216-2, the inbound weigh-in monitoring zone 218-1, and outbound weigh-in monitoring zone 218-2, are shown in FIG. 2 to have a particular shape, this is merely for illustrative purposes and the present disclosure is not so limited. Any zone of the load handling site monitored by the vehicle detection camera(s) 102 described herein, such as the load handling monitoring zone 214, the inbound bypass monitoring zone 216-1, the outbound bypass monitoring zone 216-2, the inbound weigh-in monitoring zone 218-1, and outbound weigh-in monitoring zone 218-2, may have any suitable shape.

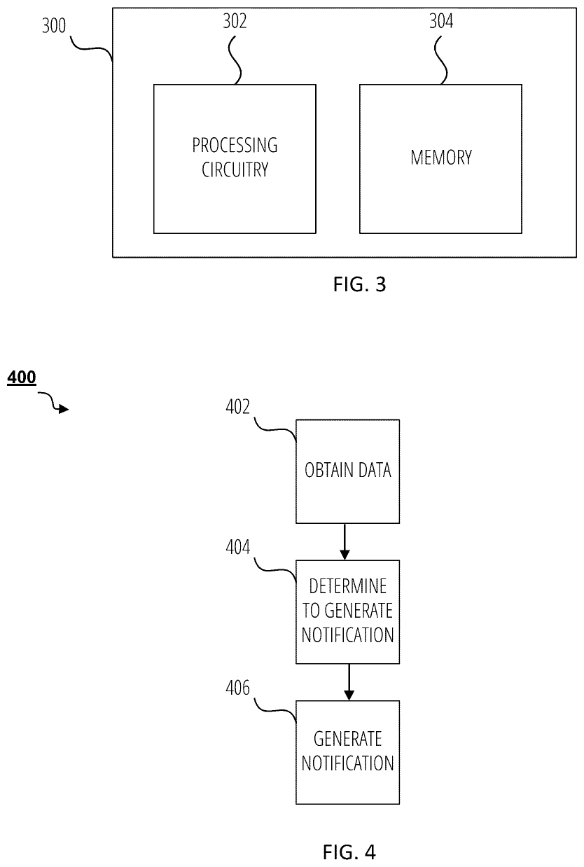

FIG. 3 schematically illustrates an apparatus 300 for indicating a lack of compliance with a load handling procedure at a load handling site, such as the load handling procedure described above in relation to FIG. 1 and FIG. 2.

It is to be understood that any of the techniques or features discussed herein may be combined in any combination with any of the techniques or features discussed in the following in relation to the apparatus 300.

The apparatus 300 comprises processing circuitry 302. The apparatus 300 may additionally comprise at least one memory 304 communicatively coupled to the processing circuitry 302. The processing circuitry 302 may comprise general purpose processing circuitry or special purpose processing circuitry. The processing circuitry 302 may be processing circuitry of one or more (e.g. cloud) servers (e.g. one or more processing circuitries distributed across one or more (e.g. cloud) servers)), or any other type of processing circuitry. The functionality of the processing circuitry 302 described herein may be implemented in software (e.g. such as software executed by processing circuitry of one or more (e.g. cloud) servers, or software executed by any other type of processing circuitry), hardware or firmware, or a combination of any of software, hardware, and firmware. For example, the processing circuitry 302 may be configured to retrieve and execute computer program instructions stored in the at least one memory 304 to thereby provide its functionality described herein. Each of the at least one memory 304 may comprise any suitable memory such as cache memory, random access memory (RAM), read only memory (ROM), flash memory, magnetic or optical disk or any combination thereof.

The apparatus 300 may be configured to implement the functionality of the compliance indicator 104 described herein or to perform a method according the method described below in relation to FIG. 4. It may be that to implement said functionality or to perform said method, the processing circuitry 302 is (e.g. directly or e.g. indirectly e.g. by way of intervening circuitry) communicatively couplable or coupled by way of any suitable communicative coupling to one or more storage devices, such as the storage device(s) 106 discussed in relation to FIGS. 1 and 2. Additionally or alternatively, it may be that to implement said functionality or to perform said method, the processing circuitry 302 is (e.g. directly or e.g. indirectly e.g. by way of intervening circuitry) communicatively couplable or coupled by way of any suitable communicative coupling to one or more electronic devices, such as the one or more electronic devices 114 discussed in relation to FIGS. 1 and 2.

It may be that the processing circuitry 302 is configured to obtain data (e.g. such as the vehicle data described in relation to FIGS. 1 and 2) indicating whether a vehicle identifier was detected in a load handling monitoring zone of the load handling site during a visit thereto by a corresponding vehicle; and whether the vehicle performed at least one action at the load handling site during the visit. For example, the processing circuitry 302 may obtain the data from one or more storage devices communicatively couplable or coupled thereto (e.g. such as the storage device(s) 106 discussed in relation to FIGS. 1 and 2), in accordance with examples disclosed herein. The at least one action may comprise or correspond to any one or more actions described herein, such as any one or more non-compliant actions, or any one or more other actions.

It may be that the processing circuitry 302 is configured to determine whether to, and to correspondingly generate a notification indicating the vehicle to have not complied with the load handling procedure during the visit depending on the obtained data, in accordance with examples disclosed herein.

It may be that the notification generated by the processing circuitry 302 corresponds to (e.g. comprises corresponding data to that of) any notification disclosed herein.

It may be that the processing circuitry 302 is operable to cause provision of (e.g. provide e.g. transmit) the notification to one or more (e.g. authorised) users or user accounts thereof, in accordance with examples disclosed herein. For example, it may be that the processing circuitry 302 is configured to cause provision of said notification by way of transmitting said notification to one or more electronic devices communicatively couplable or coupled thereto (e.g. such as the one or more electronic devices 114 discussed in relation to FIGS. 1 and 2), in accordance with examples disclosed herein.

It may be that the load handling site comprises one or more barriers, in accordance with examples disclosed herein. In such examples, it may be that the processing circuitry 302 is operable to lock or cause the locking of any one or more of said barriers in a closed position (e.g. by way of signaling to an electronically controllable lock of said barriers) responsive to the generation of a notification indicating a lack of compliance between the vehicle and the load handling procedure during the visit, in accordance with examples disclosed herein.

FIG. 4 depicts a flow diagram 400 of a (e.g. computer implemented) method for indicating a lack of compliance with a load handling procedure. The method 400 may be performed by, for example, the compliance indicator 104 discussed in relation to FIG. 1 and FIG. 2, the apparatus 300 discussed in relation to FIG. 3, or by any other suitable processing circuitry or apparatus, which may be processing circuitry of one or more (e.g. cloud) servers (e.g. one or more processing circuitries distributed across one or more (e.g. cloud) servers)), or any other type of processing circuitry including general purpose processing circuitry and special purpose processing circuitry. It is to be understood that any of the techniques or features discussed herein may be combined in any combination with any of the techniques or features discussed in the following in relation to the flow diagram 400.

At block 402, data (e.g. such as vehicle data described in relation to FIGS. 1-3) may be obtained (e.g. from at least one storage device, such as the at least one storage device(s) 106), in accordance with examples disclosed herein. The data may indicate whether a vehicle identifier was detected in a load handling monitoring zone of a load handling site during a visit thereto by a corresponding vehicle, in accordance with examples disclosed herein. The data may further indicate whether the vehicle performed at least one action at the load handling site during the visit, in accordance with examples disclosed herein. The at least one action may comprise or correspond to any one or more actions described herein, such as any one or more non-compliant actions, or any one or more other actions.

At block 404, it is determined whether to generate a notification indicating the vehicle to have not complied with the load handling procedure during the visit depending on the obtained data, in accordance with examples disclosed herein.

At block 406, said notification may be generated depending on (e.g. in correspondence with) the determination at block 404, in accordance with examples disclosed herein. It may be that the notification corresponds to (e.g. comprises corresponding data to that of) any notification disclosed herein.

Additionally, at block 406, it may be that the generated notification is provided to one or more (e.g. authorised) users or user accounts thereof, in accordance with examples disclosed herein. For example, said notification may be provide to said users or user accounts thereof by way of transmitting said notification to one or more electronic devices (e.g. such as the one or more electronic devices 114 discussed in relation to FIGS. 1-3), in accordance with examples disclosed herein.

It may be that the load handling site comprises one or more barriers, in accordance with examples disclosed herein. In such examples, it may be that, at block 406, one or more of said barriers are locked or caused to be locked in a closed position (e.g. by way of signaling to an electronically controllable lock of said barriers) responsive to the generation of the notification at block 406, in accordance with examples disclosed herein.

It is to be understood that the term “repeatedly” used throughout the present specification is used to encompass any of: periodically; intermittently; cyclically; (e.g. substantially) continuously.

The functionality of any processing circuitry described herein may be implemented in software, hardware or firmware or a combination of any of software, hardware and firmware. For example, the processing circuitry may be configured to retrieve and execute computer program instructions stored in at least one memory to thereby provide its functionality described herein. Each of the at least one memory may comprise any suitable memory such as cache memory, random access memory (RAM), read only memory (ROM), flash memory, magnetic or optical disk or any combination thereof.

In examples described herein, software, where provided, may be provided in the form of a computer program product comprising instructions which, when executed by the processing circuitry, cause the processing circuitry to carry out its specified function. The software, where provided, may be stored on one or more (e.g., non-transitory) computer-readable storage media.

The methods described herein, such as the method 400, may be implemented in whole or in part by machine readable program instructions. Machine-readable program instructions may be provided on one or more transitory mediums, such as one or more transmission mediums, or on one or more non-transitory mediums, such as one or more storage mediums. These machine readable instructions (computer program code) may be implemented in a high-level procedural or object oriented programming language. However, the program(s) may be implemented in assembly or machine language, if desired. In any case, the language may be a compiled or interpreted language, and combined with hardware implementations.

Throughout the description and claims of this specification, the words “comprise” and “contain” and variations of them mean “including but not limited to”, and they are not intended to (and do not) exclude other components, integers or operations. Throughout the description and claims of this specification, the singular encompasses the plural unless the context demands otherwise. In particular, where the indefinite article is used, the specification is to be understood as contemplating plurality as well as singularity, unless the context demands otherwise. All of the features disclosed in this specification (including any accompanying claims, abstract and drawings), and all of the elements of any method or process so disclosed, may be combined in any combination, except combinations where at least some of such features and/or operations are mutually exclusive. Implementations are not restricted to the details of any foregoing examples.

1. An apparatus for indicating a lack of compliance with a load handling procedure, the apparatus comprising processing circuitry communicatively coupled to at least one memory, the processing circuitry configured to:
obtain data relating to a vehicle identifier detected at a load handling site, the data indicating: whether the vehicle identifier was detected in a load handling monitoring zone of the load handling site during a visit thereto by a corresponding vehicle; and whether the vehicle performed at least one action at the load handling site during the visit;
determine whether to generate a notification indicating the vehicle to have not complied with the load handling procedure during the visit depending on the data; and
generate the notification depending on the determination.

2. The apparatus of claim 1, wherein the at least one action comprises at least one non-compliant action.

3. The apparatus of claim 2, wherein the at least one non-compliant action comprises any one or more of: bypassing an inbound weigh-in; bypassing an outbound weigh-in; invalidly performing an inbound weigh-in; invalidly performing an outbound weigh-in; carrying a radioactive load.

4. The apparatus of claim 1, wherein the processing circuitry is configured to:
determine to generate the notification when:
the data indicates that the vehicle identifier of the vehicle was detected in the load handling monitoring zone of the load handling site during the visit; and
the data further indicates that the vehicle performed at least one non-compliant action during the visit.

5. The apparatus of claim 1, wherein the processing circuitry is configured to determine to generate the notification when:
the data indicates that the vehicle identifier of the vehicle was detected in the load handling monitoring zone of the load handling site during the visit; and
the data further indicates that the vehicle identifier of the vehicle was detected in at least one non-compliant zone of the load handling site during the visit.

6. The apparatus of claim 1, wherein the processing circuitry is configured to determine to generate the notification when:
the data indicates that the vehicle identifier of the vehicle was detected in the load handling monitoring zone of the load handling site during the visit; and
the data further indicates that the vehicle identifier of the vehicle was not detected in at least one compliant zone of the load handling site during the visit.

7. The apparatus of claim 1, wherein the processing circuitry is configured to determine to generate the notification when:
the data indicates that the vehicle identifier of the vehicle was detected in the load handling monitoring zone of the load handling site during the visit; and
the data further indicates that the vehicle identifier of the vehicle was detected in at least one bypass monitoring zone of the load handling site during the visit.

8. The apparatus of claim 1, wherein the processing circuitry is configured to determine to generate the notification when:
the data indicates that the vehicle identifier of the vehicle was detected in the load handling monitoring zone of the load handling site during the visit; and
the data further indicates that the vehicle identifier of the vehicle was not detected in at least one weigh-in monitoring zone of the load handling site during the visit.

9. The apparatus of claim 1, wherein the processing circuitry is configured to determine to generate the notification when:
the data indicates that the vehicle identifier of the vehicle was detected in the load handling monitoring zone of the load handling site during the visit; and
the data further indicates at least one measured weight of the vehicle to be outside of a predetermined valid weight range.

10. The apparatus of claim 1, wherein the processing circuitry is configured to determine to generate the notification when:
the data indicates that the vehicle identifier of the vehicle was detected in the load handling monitoring zone of the load handling site during the visit; and
the data further indicates the vehicle to have been invalidly positioned during at least one weigh-in during the visit.

11. The apparatus of claim 1, wherein the processing circuitry is configured to determine to generate the notification when:
the data indicates that the vehicle identifier of the vehicle was detected in the load handling monitoring zone of the load handling site during the visit; and
the data further indicates the vehicle to have been carrying a radioactive load during the visit.

12. The apparatus of claim 1, wherein the processing circuitry is configured to determine to generate the notification when:
the data indicates that the vehicle identifier of the vehicle was not detected in the load handling monitoring zone of the load handling site during the visit; and
the data further indicates the vehicle to have been detected in at least one other monitoring zone of the load handling site during the visit.

13. The apparatus of claim 12, wherein the at least one other monitoring zone comprises any one or more of: an inbound weigh-in monitoring zone; an outbound weigh-in monitoring zone; an inbound bypass monitoring zone; an outbound bypass monitoring zone.

14. The apparatus of claim 1, wherein the processing circuitry is configured to cause provision of the notification to one or more users or user accounts thereof.

15. The apparatus of claim 14, wherein the processing circuitry is configured to email the notification to respective email accounts of the one or more users.

16. The apparatus of claim 14, wherein the processing circuitry is configured to cause provision of the notification to an online portal or a web application.

17. The apparatus of claim 14, wherein the processing circuitry is configured to cause transmission of the notification to respective user devices of the one or more users.

18. The apparatus of claim 1, wherein the vehicle identifier comprises a registration number of the vehicle.

19. The apparatus of claim 1, wherein the load handling site is one of: a refuse disposal site; a quarry.

20. A system comprising:
the apparatus of claim 1;
one or more vehicle detection cameras; and
at least one storage device communicatively coupled to each of the apparatus and the one or more vehicle detection cameras.

21-24. (canceled)
